(19) United States
(12) Patent Application Publication
(10) Pub. No.: US 2026/0312841 A1
(43) Pub. Date: Oct. 8, 2026

(54) TECHNIQUES FOR SOUNDING REFERENCE SIGNAL BASED BEAMFORMING

(71) Applicant: QUALCOMM Incorporated, San Diego, CA (US)

(72) Inventors: Andrei Dragos RADULESCU, La Jolla, CA (US); Michael Francis GARYANTES, Bradley Beach, NJ (US); Abhishek Saurabh SACHIDANAND SINHA, San Diego, CA (US); Mark WALLACE, Bedford, MA (US); Deepak AGARWAL, San Diego, CA (US); Jigneshkumar SHAH, San Diego, CA (US); Rajat PRAKASH, San Diego, CA (US); Xiaoxia ZHANG, San Diego, CA (US); Mostafa KHOSHNEVISAN, San Diego, CA (US); Andrea GARAVAGLIA, Nuremberg (DE)

(21) Appl. No.: 19/545,477

(22) Filed: Feb. 20, 2026

Related U.S. Application Data
(60) Provisional application No. 63/785,159, filed on Apr. 8, 2025.

(51) Int. Cl. H04L 25/02; H04B 7/06; H04L 5/00; H04W 8/22

(52) U.S. Cl. CPC H04L 25/0224; H04B 7/0617; H04L 5/0051; H04L 25/0242; H04W 8/22

(57) ABSTRACT

Various aspects of the present disclosure generally relate to wireless communication. In some aspects, a first network node may receive, from a second network node, a configuration associated with a sounding reference signal (SRS) for channel estimation associated with a user equipment (UE), wherein the configuration indicates at least one report type associated with the SRS. The first network node may receive, from the UE, the SRS in accordance with the configuration. The first network node may transmit, to the second network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE. Numerous other aspects are described.

### CROSS-REFERENCE TO RELATED APPLICATION

This patent application claims priority to U.S. Provisional Patent Application No. 63/785,159, filed on Apr. 8, 2025, entitled “TECHNIQUES FOR SOUNDING REFERENCE SIGNAL BASED BEAMFORMING,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with sounding reference signal based beamforming, channel estimation, and beam weights.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, a sounding reference signal (SRS) may be transmitted by a user equipment (UE), and a network node may perform channel estimation to measure and analyze channel conditions associated with communications with the UE. For example, the SRS may be monitored by the network node, and the measurements may be used to derive a channel estimation and beamforming weights. In some systems, such as those operating in accordance with open radio access network (O-RAN) techniques, beamforming and channel estimation techniques may be performed or rely on communication between multiple network nodes, such as a distributed unit (DU) and a radio unit (RU).

### SUMMARY

The systems, methods, and devices of this disclosure each have several innovative aspects, no single one of which is solely responsible for the desirable attributes disclosed herein.

Some aspects described herein relate to a method of wireless communication performed by a first network node. The method may include receiving, from a second network node, a configuration associated with a sounding reference signal (SRS) for channel estimation associated with a user equipment (UE), wherein the configuration indicates at least one report type associated with the SRS. The method may include receiving, from the UE, the SRS in accordance with the configuration. The method may include transmitting, to the second network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE.

Some aspects described herein relate to a method of wireless communication performed by a first network node. The method may include receiving a first message from a UE or a network node, wherein a channel estimation for one or more ports associated with the UE are based at least in part on the first message. The method may include receiving, from a second network node, a second message including beamforming information associated with a set of one or more UE ports associated with the UE, wherein the beamforming information includes a mapping from the set of one or more UE ports to a set of one or more logical ports.

Some aspects described herein relate to a method of wireless communication performed by a first network node. The method may include transmitting, to a second network node, capability information associated with a grouping of one or more UE ports associated with at least one UE. The method may include receiving, from the second network node, an indication of the grouping of the one or more UE ports based at least in part on the capability information. The method may include receiving, from the second network node, an indication that the grouping is associated with a downlink transmission or at least one UE port of the one or more UE ports for channel estimation to be derived based at least in part on sampling of an SRS from the at least one UE.

Some aspects described herein relate to a method of wireless communication performed by a first network node. The method may include transmitting, to a second network node, a configuration associated with an SRS for channel estimation associated with a UE, wherein the configuration indicates at least one report type associated with the SRS. The method may include receiving, from the second network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE.

Some aspects described herein relate to a method of wireless communication performed by a first network node. The method may include transmitting, to a second network node, a second message including beamforming information associated with a set of one or more UE ports associated with a UE, wherein the beamforming information includes a mapping from the set of one or more UE ports to a set of one or more logical ports.

Some aspects described herein relate to a method of wireless communication performed by a first network node. The method may include receiving, from a second network node, capability information associated with a grouping of one or more UE ports associated with at least one UE. The method may include transmitting, to the second network node, an indication of the grouping of the one or more UE ports based at least in part on the capability information. The method may include transmitting, to the second network node, an indication that the grouping is associated with a downlink transmission or at least one UE port of the one or more UE ports for channel estimation to be derived based at least in part on sampling of an SRS from the at least one UE.

Some aspects described herein relate to a method of wireless communication performed by a UE. The method may include receiving, from a network node, a configuration associated with an SRS for channel estimation associated with the UE, wherein the configuration indicates at least one report type associated with the SRS. The method may include transmitting, to the network node, an SRS in accordance with a configuration associated with channel estimation, wherein the channel estimation includes a mapping between a channel estimation for one or more SRS ports associated with the UE and a channel estimation for one or more logical ports associated with the UE in accordance with the at least one report type.

Some aspects described herein relate to a first network node. The first network node may include a processing system. The processing system may include one or more processors and one or more code-storing memories coupled with the one or more processors. The processing system may be configured to cause the first network node to receive, from a second network node, a configuration associated with an SRS for channel estimation associated with a UE, wherein the configuration indicates at least one report type associated with the SRS. The processing system may be configured to cause the first network node to receive, from the UE, the SRS in accordance with the configuration. The processing system may be configured to cause the first network node to transmit, to the second network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE.

Some aspects described herein relate to a first network node. The first network node may include a processing system. The processing system may include one or more processors and one or more code-storing memories coupled with the one or more processors. The processing system may be configured to cause the first network node to receive a first message from a UE or a network node, wherein a channel estimation for one or more ports associated with the UE are based at least in part on the first message. The processing system may be configured to cause the first network node to receive a second message including beamforming information associated with a set of one or more UE ports associated with the UE, wherein the beamforming information includes a mapping from the set of one or more UE ports to a set of one or more logical ports.

Some aspects described herein relate to a first network node. The first network node may include a processing system. The processing system may include one or more processors and one or more code-storing memories coupled with the one or more processors. The processing system may be configured to cause the first network node to transmit, to a second network node, capability information associated with a grouping of one or more UE ports associated with at least one UE. The processing system may be configured to cause the first network node to receive, from the second network node, an indication of the grouping of the one or more UE ports based at least in part on the capability information. The processing system may be configured to cause the first network node to receive, from the second network node, an indication that the grouping is associated with a downlink transmission or at least one UE port of the one or more UE ports for channel estimation to be derived based at least in part on sampling of an SRS from the at least one UE.

Some aspects described herein relate to a first network node. The first network node may include a processing system. The processing system may include one or more processors and one or more code-storing memories coupled with the one or more processors. The processing system may be configured to cause the first network node to transmit, to a second network node, a configuration associated with an SRS for channel estimation associated with a UE, wherein the configuration indicates at least one report type associated with the SRS. The processing system may be configured to cause the first network node to receive, from the second network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE.

Some aspects described herein relate to a first network node. The first network node may include a processing system. The processing system may include one or more processors and one or more code-storing memories coupled with the one or more processors. The processing system may be configured to cause the first network node to receive, from a second network node, a second message including beamforming information associated with a set of one or more UE ports associated with a UE, wherein the beamforming information includes a mapping from the set of one or more UE ports to a set of one or more logical ports.

Some aspects described herein relate to a network node. The network node may include a processing system. The processing system may include one or more processors and one or more code-storing memories coupled with the one or more processors. The processing system may be configured to cause the network node to receive, from a second network node, capability information associated with a grouping of one or more UE ports associated with at least one UE. The processing system may be configured to cause the network node to transmit, to the second network node, an indication of the grouping of the one or more UE ports based at least in part on the capability information. The processing system may be configured to cause the network node to transmit, to the second network node, an indication that the grouping is associated with a downlink transmission or at least one UE port of the one or more UE ports for channel estimation to be derived based at least in part on sampling of an SRS from the at least one UE.

Some aspects described herein relate to a UE. The UE may include a processing system. The processing system may include one or more processors and one or more code-storing memories coupled with the one or more processors. The processing system may be configured to cause the UE to receive, from a second network node, a configuration associated with an SRS for channel estimation associated with the UE, wherein the configuration indicates at least one report type associated with the SRS. The processing system may be configured to cause the UE to transmit, to the network node, an SRS in accordance with a configuration associated with channel estimation, wherein the channel estimation includes a mapping between a channel estimation for one or more SRS ports associated with the UE and a channel estimation for one or more logical ports associated with the UE in accordance with the at least one report type.

Some aspects described herein relate to a non-transitory computer-readable medium that stores a set of instructions for wireless communication by a first network node. The set of instructions, when executed by one or more processors of the first network node, may cause the first network node to receive a first message from a UE or a network node, wherein a channel estimation for one or more ports associated with the UE are based at least in part on the first message. The set of instructions, when executed by one or more processors of the first network node, may cause the first network node to receive a second message including beamforming information associated with a set of one or more UE ports associated with the UE, wherein the beamforming information includes a mapping from the set of one or more UE ports to a set of one or more logical ports.

Some aspects described herein relate to a non-transitory computer-readable medium that stores a set of instructions for wireless communication by a first network node. The set of instructions, when executed by one or more processors of the first network node, may cause the first network node to receive a first message from a UE or a network node, wherein a channel estimation for one or more ports associated with the UE are based at least in part on the first message. The set of instructions, when executed by one or more processors of the first network node, may cause the first network node to receive a second message including beamforming information associated with a set of one or more UE ports associated with the UE, wherein the beamforming information includes a mapping from the set of one or more UE ports to a set of one or more logical ports.

Some aspects described herein relate to a non-transitory computer-readable medium that stores a set of instructions for wireless communication by a first network node. The set of instructions, when executed by one or more processors of the first network node, may cause the first network node to transmit, to a second network node, capability information associated with a grouping of one or more UE ports associated with at least one UE. The set of instructions, when executed by one or more processors of the first network node, may cause the first network node to receive, from the second network node, an indication of the grouping of the one or more UE ports based at least in part on the capability information. The set of instructions, when executed by one or more processors of the first network node, may cause the first network node to receive, from the second network node, an indication that the grouping is associated with a downlink transmission or at least one UE port of the one or more UE ports for channel estimation to be derived based at least in part on sampling of an SRS from the at least one UE.

Some aspects described herein relate to a non-transitory computer-readable medium that stores a set of instructions for wireless communication by a first network node. The set of instructions, when executed by one or more processors of the first network node, may cause the first network node to transmit, to a second network node, a configuration associated with an SRS for channel estimation associated with a UE, wherein the configuration indicates at least one report type associated with the SRS. The set of instructions, when executed by one or more processors of the first network node, may cause the first network node to receive, from the second network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE.

Some aspects described herein relate to a non-transitory computer-readable medium that stores a set of instructions for wireless communication by a first network node. The set of instructions, when executed by one or more processors of the first network node, may cause the first network node to receive, from a second network node, a second message including beamforming information associated with a set of one or more UE ports associated with a UE, wherein the beamforming information includes a mapping from the set of one or more UE ports to a set of one or more logical ports.

Some aspects described herein relate to a non-transitory computer-readable medium that stores a set of instructions for wireless communication by a network node. The set of instructions, when executed by one or more processors of the network node, may cause the network node to receive, from a second network node, capability information associated with a grouping of one or more UE ports associated with at least one UE. The set of instructions, when executed by one or more processors of the network node, may cause the network node to transmit, to the second network node, an indication of the grouping of the one or more UE ports based at least in part on the capability information. The set of instructions, when executed by one or more processors of the network node, may cause the network node to transmit, to the second network node, an indication that the grouping is associated with a downlink transmission or at least one UE port of the one or more UE ports for channel estimation to be derived based at least in part on sampling of an SRS from the at least one UE.

Some aspects described herein relate to a non-transitory computer-readable medium that stores a set of instructions for wireless communication by a UE. The set of instructions, when executed by one or more processors of the UE, may cause the UE to receive, from a second network node, a configuration associated with an SRS for channel estimation associated with a UE, wherein the configuration indicates at least one report type associated with the SRS. The set of instructions, when executed by one or more processors of the UE, may cause the UE to transmit, to a network node, an SRS in accordance with a configuration associated with channel estimation, wherein the channel estimation includes a mapping between a channel estimation for one or more SRS ports associated with the UE and a channel estimation for one or more logical ports associated with the UE in accordance with the at least one report type.

Some aspects described herein relate to an apparatus for wireless communication. The apparatus may include means for receiving, from a network node, a configuration associated with an SRS for channel estimation associated with a UE, wherein the configuration indicates at least one report type associated with the SRS. The apparatus may include means for receiving, from the UE, the SRS in accordance with the configuration. The apparatus may include means for transmitting, to the network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE.

Some aspects described herein relate to an apparatus for wireless communication. The apparatus may include means for receiving a first message from a UE or a network node, wherein a channel estimation for one or more ports associated with the UE are based at least in part on the first message. The apparatus may include means for receiving a second message including beamforming information associated with a set of one or more UE ports associated with the UE, wherein the beamforming information includes a mapping from the set of one or more UE ports to a set of one or more logical ports.

Some aspects described herein relate to an apparatus for wireless communication. The apparatus may include means for transmitting, to a network node, capability information associated with a grouping of one or more UE ports associated with at least one UE. The apparatus may include means for receiving, from the network node, an indication of the grouping of the one or more UE ports based at least in part on the capability information. The apparatus may include means for receiving, from the network node, an indication that the grouping is associated with a downlink transmission or at least one UE port of the one or more UE ports for channel estimation to be derived based at least in part on sampling of an SRS from the at least one UE.

Some aspects described herein relate to an apparatus for wireless communication. The apparatus may include means for transmitting, to a network node, a configuration associated with an SRS for channel estimation associated with a UE, wherein the configuration indicates at least one report type associated with the SRS. The apparatus may include means for receiving, from the network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE.

Some aspects described herein relate to an apparatus for wireless communication. The apparatus may include means for receiving, from a network node, a second message including beamforming information associated with a set of one or more UE ports associated with a UE, wherein the beamforming information includes a mapping from the set of one or more UE ports to a set of one or more logical ports.

Some aspects described herein relate to an apparatus for wireless communication. The apparatus may include means for receiving, from a network node, capability information associated with a grouping of one or more UE ports associated with at least one UE. The apparatus may include means for transmitting, to the network node, an indication of the grouping of the one or more UE ports based at least in part on the capability information. The apparatus may include means for transmitting, to the network node, an indication that the grouping is associated with a downlink transmission or at least one UE port of the one or more UE ports for channel estimation to be derived based at least in part on sampling of an SRS from the at least one UE.

Some aspects described herein relate to an apparatus for wireless communication. The apparatus may include means for receiving, from a network node, a configuration associated with an SRS for channel estimation associated with a UE, wherein the configuration indicates at least one report type associated with the SRS. The apparatus may include means for transmitting, to the network node, an SRS in accordance with a configuration associated with channel estimation, wherein the channel estimation includes a mapping between a channel estimation for one or more SRS ports associated with the UE and a channel estimation for one or more logical ports associated with the UE in accordance with the at least one report type.

Aspects of the present disclosure may generally be implemented by or as a method, apparatus, system, computer program product, non-transitory computer-readable medium, user equipment, network node, wireless communication device, or processing system as substantially described in the Detailed Description with respect to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of sounding reference signal (SRS) resource sets.

FIG. 4 is a diagram illustrating an example of multiple user multiple-input multiple-output.

FIG. 5 illustrates an example associated with SRS based beamforming at a radio unit (RU).

FIG. 6 illustrates an example associated with SRS based beamforming at an RU.

FIGS. 7-12 are diagrams illustrating example processes performed, for example, at a network node or an apparatus of a network node.

FIG. 13 is a diagram illustrating an example process performed, for example, at a user equipment or an apparatus of a user equipment.

FIGS. 14-16 are diagrams of example apparatuses for wireless communication.

### DETAILED DESCRIPTION

In some wireless communication systems, beamforming techniques may be used to direct signals toward specific receivers, thereby enhancing signal strength and reducing interference. In some aspects, a network node may perform beamforming for communications with a user equipment (UE). For example, the network node may rely on channel estimation, which may be facilitated by the transmission of a sounding reference signal (SRS) by the UE.

In some examples, SRSs may be transmitted by a UE, and the network node may perform channel estimation to measure and analyze the channel conditions. For example, an SRS may be monitored by a network node, and the measurements may be used to derive a channel estimation and beamforming weights. In some systems, such as those operating in accordance with open radio access network (O-RAN) techniques, beamforming and channel estimation techniques may be performed or rely on communication between multiple network nodes, such as a distributed unit (DU) and a radio unit (RU).

In some O-RAN systems, for example, beamforming (e.g., beam weight selection) for a UE may be performed at a DU. For example, in channel information based beamforming (CIBF), the DU may perform beamforming based on an SRS transmitted from the UE to an RU, and the RU may transmit an indication of the received signal (e.g., an effective channel) for the DU to perform beamforming. In some cases, it may be beneficial for the RU to perform beamforming, which may reduce latency or overhead associated with communications between the RU and the DU. For example, in uplink performance improvement (ULPI), the RU may measure a demodulation reference signal (DMRS) from the UE to perform beamforming and channel estimation in accordance with an uplink DMRS configuration. However, the DMRS measurements may not be sufficient to perform scheduling for the UE, as the DMRS transmissions may be less robust relative to SRS transmissions. Accordingly, techniques for supporting SRS-based beamforming at the RU may be beneficial.

However, there may be challenges associated with implementing SRS based beamforming at the RU. For example, the RU should discern a usage type associated with the SRS waveform (e.g., whether it will be used for uplink, downlink, or both, which may be referred to as an overload case), which may be configured by the DU. Additionally, as the SRS is received and processed at the RU, the DU may be unaware of information that may be useful for scheduling, which may still be performed at the DU. Furthermore, a distinction between channel estimation for SRS ports and logical ports may be unclear, which may cause challenges for communication of channel estimation information between the RU and the DU.

Various aspects relate generally to techniques for supporting SRS beamforming at the RU. Some aspects more specifically relate to techniques for beamforming, channel estimation, and beam weight generation at the RU, while supporting the reporting of information associated with the SRS from the RU to the DU. In some aspects, the RU may receive a configuration from the DU associated with transmission of reports associated with an SRS. In some cases, the RU may be configured to report SRS channel estimation for SRS ports or logical ports. In some aspects, the RU may select to report channel estimations based on context. For example, the RU may report channel estimations for SRS ports when the report is associated with uplink scheduling, and channel estimations for logical ports may be reported when the report is associated with downlink scheduling. Additionally, or alternatively, the DU may be configured to indicate a usage type for the SRS or a report type for the report, and the report may be in accordance with the indicated report type or usage type. In some aspects, the RU may include a mapping that links a channel estimation for logical ports to a channel estimation for SRS ports. For example, the mapping may include a transformation matrix that may be used to convert the channel estimation for the logical ports to a channel estimation for the SRS ports. In some aspects, the RU may be configured to combine an SRS channel estimation with ULPI channel estimation based on reception of a DMRS from the UE. For example, the SRS channel estimation and the ULPI channel estimation may be combined to improve channel estimation for one or more slots or to enhance calculation of second order statistics (e.g., a power delay profile, or a Doppler spread), or the SRS reception may be used as a spatial prefilter for reception of the DMRS.

Particular aspects of the subject matter described in this disclosure can be implemented to realize one or more of the following potential advantages. In some examples, the described techniques can be used to enhance the precision of channel estimation and the efficiency of beamforming algorithms by utilizing detailed SRS configuration, while allowing effective scheduling at the DU by reporting information associated with the SRS via a report from the RU. For example, as the RU may be configured to provide channel estimation relative to either SRS ports and logical ports, the reporting by the RU may be adapted to the scheduling to be performed at the DU, which may reduce additional signaling overhead and processing resources associated with the DU requesting information for scheduling. Additionally, or alternatively, by including a mapping within the report to allow for transforming between SRS port and logical port-based SRS channel estimations, the DU may use a channel estimate that may be suited to operations (e.g., scheduling) to be performed by the DU. Furthermore, by combining ULPI with SRS-based channel estimations, the techniques described herein may enhance channel estimation techniques at the RU, thereby improving beamforming performance.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mm Wave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

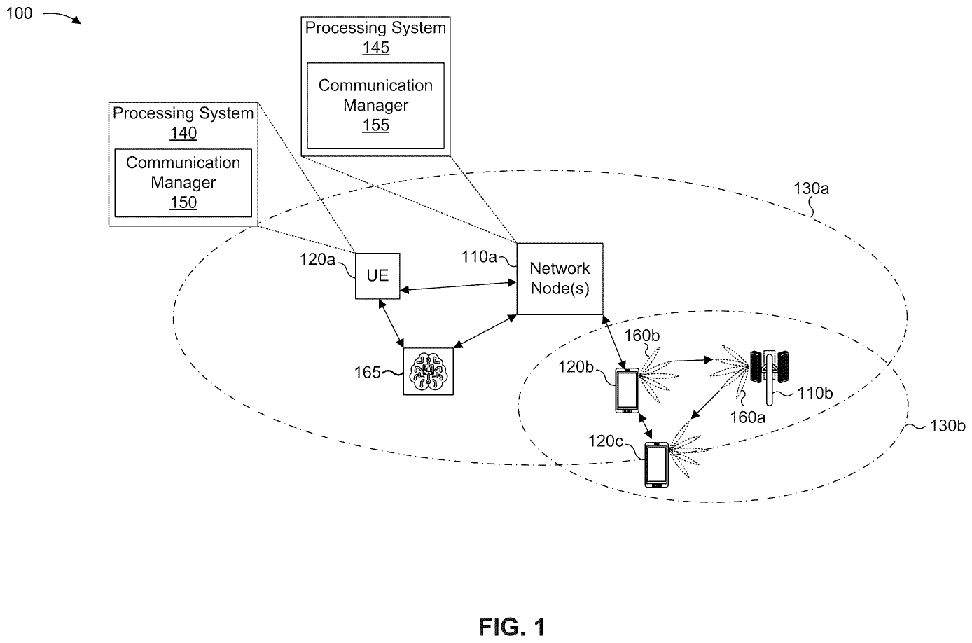

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an O-RAN (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may be or may include one or more central units (CUs), one or more DUs, and one or more RUs. A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mm Wave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the network node 110 may include a communication manager 155. As described in more detail elsewhere herein, the communication manager 155 may receive, from a second network node, a configuration associated with an SRS for channel estimation associated with a UE, wherein the configuration indicates at least one report type associated with the SRS; receive, from the UE, the SRS in accordance with the configuration; and transmit, to the second network node, a report associated with the at least one report type, the report indicating a channel estimation based at least in part on the SRS, wherein the channel estimation includes at least one of a channel estimation for one or more SRS ports associated with the UE or a channel estimation for one or more logical ports associated with the UE.

Additionally, or alternatively, the communication manager 155 may receive a first message from a UE or a network node, wherein a channel estimation for one or more ports associated with the UE are based at least in part on the first message; receive, from a second network node, a second message including beamforming information associated with a set of one or more UE ports associated with the UE, wherein the beamforming information includes a mapping from the set of one or more UE ports to a set of one or more logical ports.

Additionally, or alternatively, the communication manager 155 may transmit, to a second network node, capability information associated with a grouping of one or more UE ports associated with a UE; receive, from the second network node, an indication of the grouping of the one or more UE ports based at least in part on the capability information; and receive, from the second network node, an indication that the grouping is associated with a downlink transmission or at least one UE port of the one or more UE ports for channel estimation to be derived based at least in part on sampling of an SRS from the UE.

Additionally, or alternatively, the communication manager 155 may transmit, to a second network node, a configuration associated with an SRS for channel estimation associated with a UE, wherein the configuration indicates at least one report type associated with the SRS; receive, from the second network node, a report associated with the at least one report type, the report indicating a channel estimation based at least in part on the SRS, wherein the channel estimation includes at least one of a channel estimation for one or more SRS ports associated with the UE or a channel estimation for one or more logical ports associated with the UE.

Additionally, or alternatively, the communication manager 155 may transmit, to a second network node, a second message including beamforming information associated with a set of one or more UE ports associated with a UE, wherein the beamforming information includes a mapping from the set of one or more UE ports to a set of one or more logical ports.

Additionally, or alternatively, the communication manager 155 may receive, from a second network node, capability information associated with a grouping of one or more UE ports associated with a UE; transmit, to the second network node, an indication of the grouping of the one or more UE ports based at least in part on the capability information; and transmit, to the second network node, an indication that the grouping is associated with a downlink transmission or at least one UE port of the one or more UE ports for channel estimation to be derived based at least in part on sampling of an SRS from the UE. Additionally, or alternatively, the communication manager 155 may perform one or more other operations described herein.

In some aspects, the UE 120 may include a communication manager 150. As described in more detail elsewhere herein, the communication manager 150 may receive, from a network node, a configuration associated with an SRS for channel estimation associated with the UE, wherein the configuration indicates at least one report type associated with the SRS; and transmit, to the network node, an SRS in accordance with a configuration associated with channel estimation, wherein the channel estimation includes at least one of a channel estimation for one or more SRS ports associated with the UE or a channel estimation for one or more logical ports associated with the UE in accordance with the at least one report type. Additionally, or alternatively, the communication manager 150 may perform one or more other operations described herein.

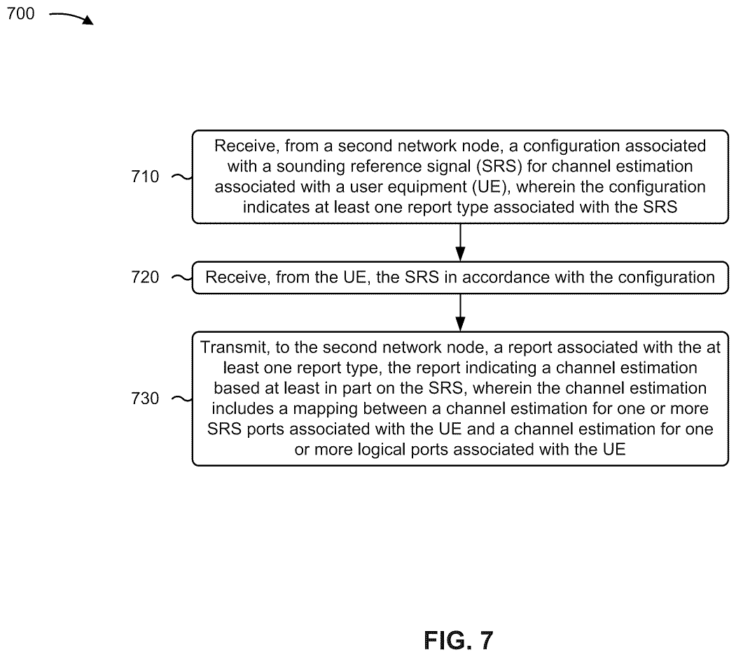

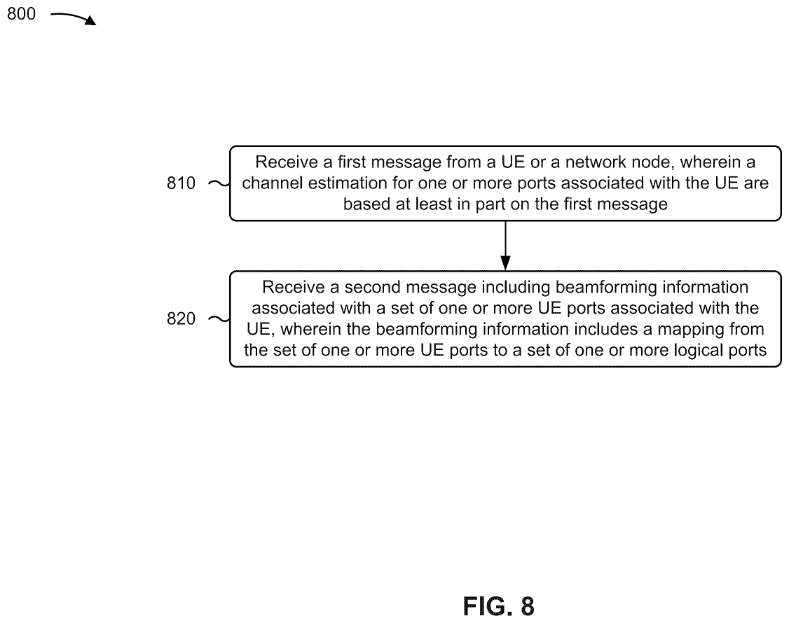

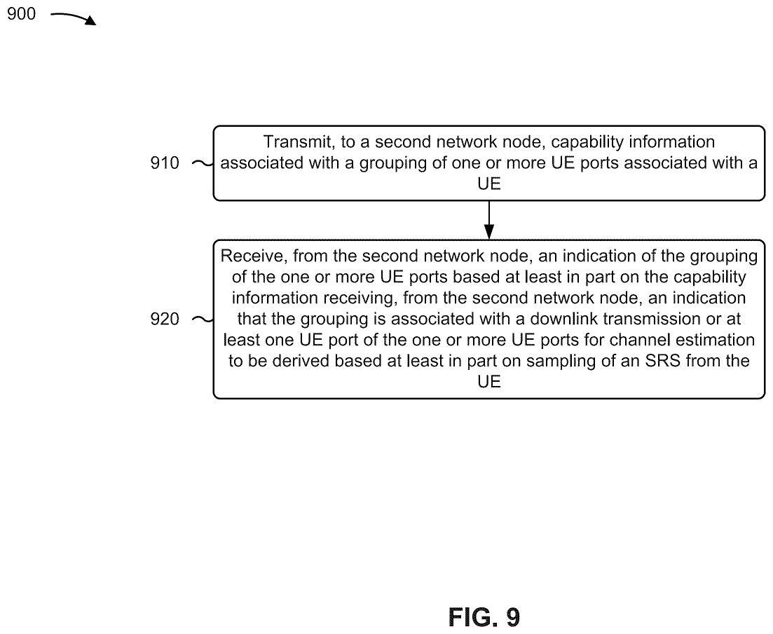

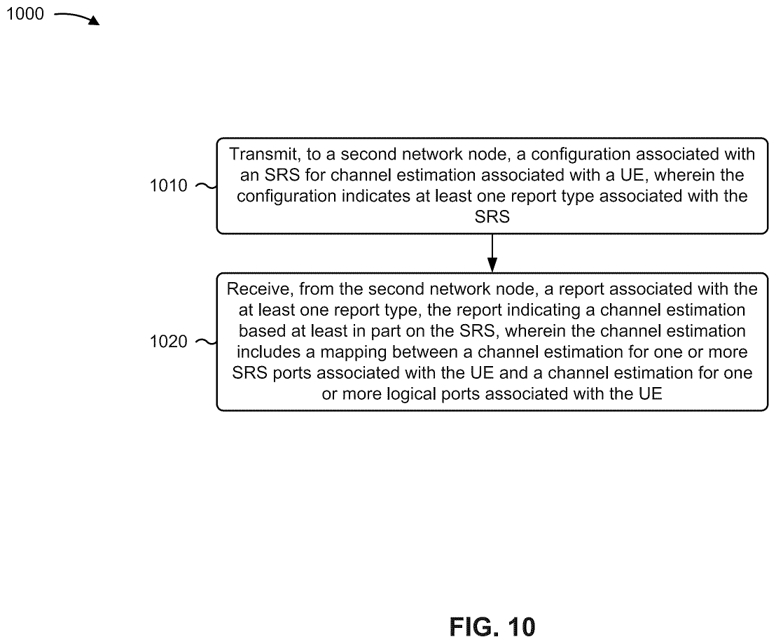

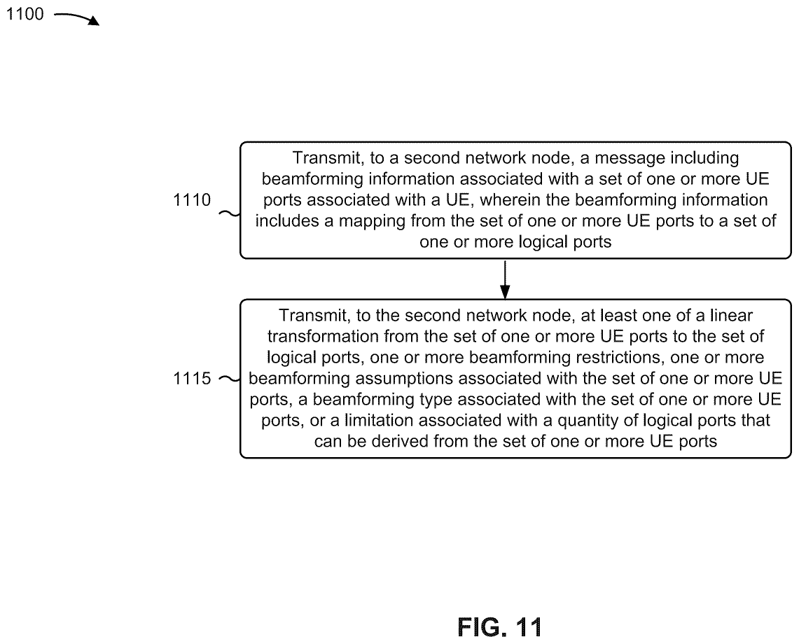

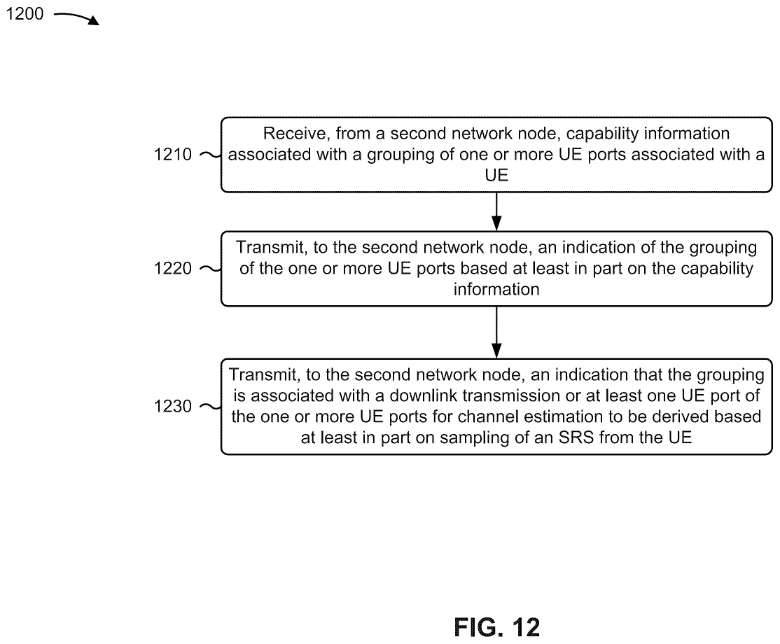

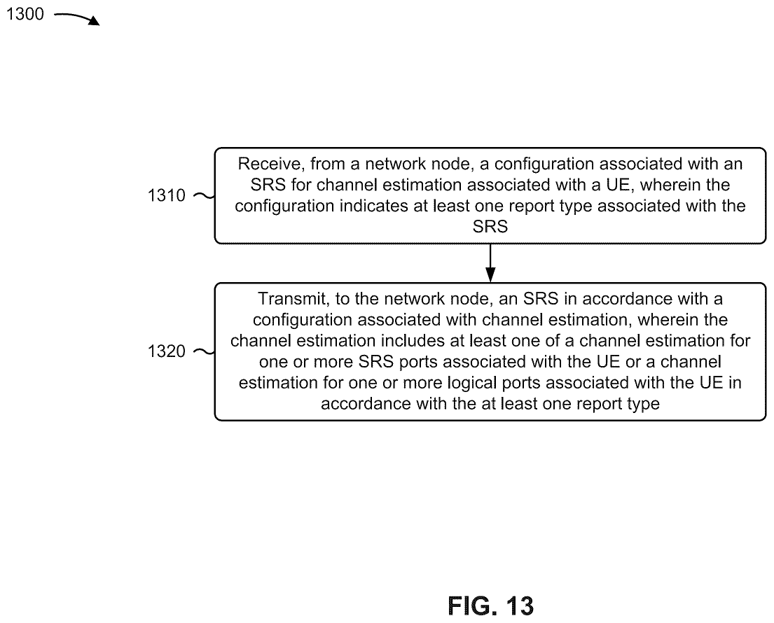

The network node 110 (e.g., an RU, or a DU), the processing system 145 of the network node 110, the UE 120, the processing system 140 of the UE 120, or any other component(s) of FIG. 1 may implement one or more techniques or perform one or more operations associated with SRS based beamforming at an RU, as described in more detail elsewhere herein. For example, the processing system 145 of the network node 110, or the processing system 140 of the UE 120 may perform or direct operations of, for example, process 700 of FIG. 7, process 800 of FIG. 8, process 900 of FIG. 9, process 1000 of FIG. 10, process 1100 of FIG. 11, process 1200 of FIG. 12, process 1300 of FIG. 13 or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 700 of FIG. 7, process 800 of FIG. 8, process 900 of FIG. 9, process 1000 of FIG. 10, process 1100 of FIG. 11, process 1200 of FIG. 12, process 1300 of FIG. 13 or other processes as described herein. In some examples, executing instructions may include running the instructions, converting the instructions, compiling the instructions, or interpreting the instructions, among other examples.

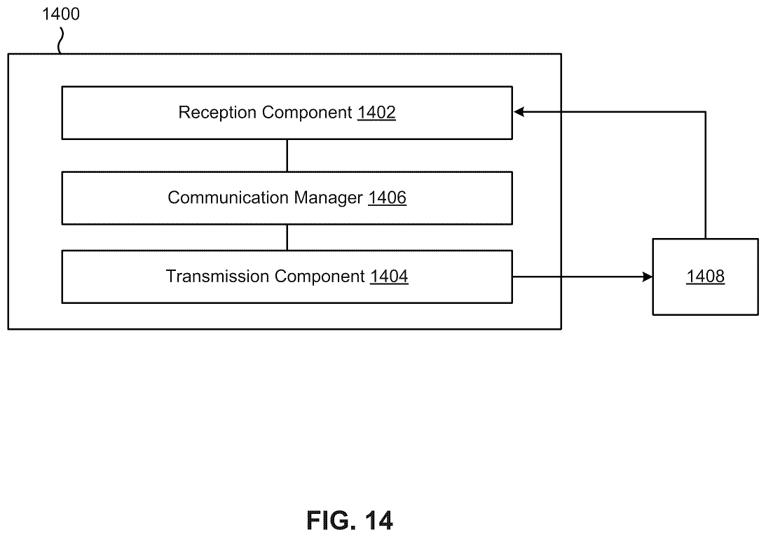

In some aspects, a first network node includes means for receiving, from a second network node, a configuration associated with an SRS for channel estimation associated with a UE, wherein the configuration indicates at least one report type associated with the SRS; means for receiving, from a UE, the SRS in accordance with the configuration; or means for transmitting, to the second network node, a report associated with the at least one report type, the report indicating a channel estimation based at least in part on the SRS, wherein the channel estimation includes at least one of a channel estimation for one or more SRS ports associated with the UE or a channel estimation for one or more logical ports associated with the UE. The means for the first network node to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

In some aspects, the first network node includes means for receiving a first message from a UE or a network node, wherein a channel estimation for one or more ports associated with the UE are based at least in part on the first message; or means for receiving, from a second network node, a second message including beamforming information associated with a set of one or more UE ports associated with the UE, wherein the beamforming information includes a mapping from the set of one or more UE ports to a set of one or more logical ports. The means for the first network node to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

In some aspects, the first network node includes means for transmitting, to a second network node, capability information associated with a grouping of one or more UE ports associated with a UE; means for receiving, from the second network node, an indication of the grouping of the one or more UE ports based at least in part on the capability information; or means for receiving, from the second network node, an indication that the grouping is associated with a downlink transmission or at least one UE port of the one or more UE ports for channel estimation to be derived based at least in part on sampling of an SRS from the UE. The means for the first network node to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

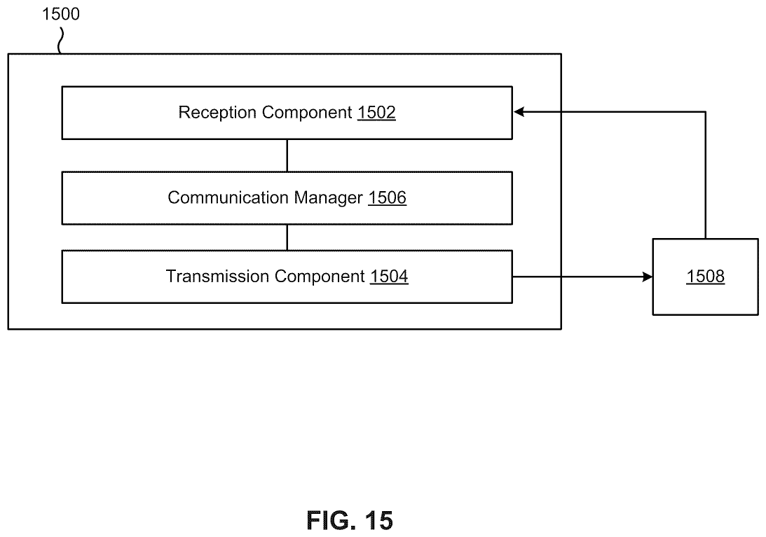

In some aspects, the first network node includes means for transmitting, to a second network node, a configuration associated with an SRS for channel estimation associated with a UE, wherein the configuration indicates at least one report type associated with the SRS; or means for receiving, from the second network node, a report associated with the at least one report type, the report indicating a channel estimation based at least in part on the SRS, wherein the channel estimation includes at least one of a channel estimation for one or more SRS ports associated with the UE or a channel estimation for one or more logical ports associated with the UE. The means for the first network node to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

In some aspects, the first network node includes means for transmitting, to a second network node, a second message including beamforming information associated with a set of one or more UE ports associated with a UE, wherein the beamforming information includes a mapping from the set of one or more UE ports to a set of one or more logical ports. The means for the first network node to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

In some aspects, the first network node includes means for receiving, from a second network node, capability information associated with a grouping of one or more UE ports associated with a UE; means for transmitting, to the second network node, an indication of the grouping of the one or more UE ports based at least in part on the capability information; or means for transmitting, to the second network node, an indication that the grouping is associated with a downlink transmission or at least one UE port of the one or more UE ports for channel estimation to be derived based at least in part on sampling of an SRS from the UE. The means for the first network node to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

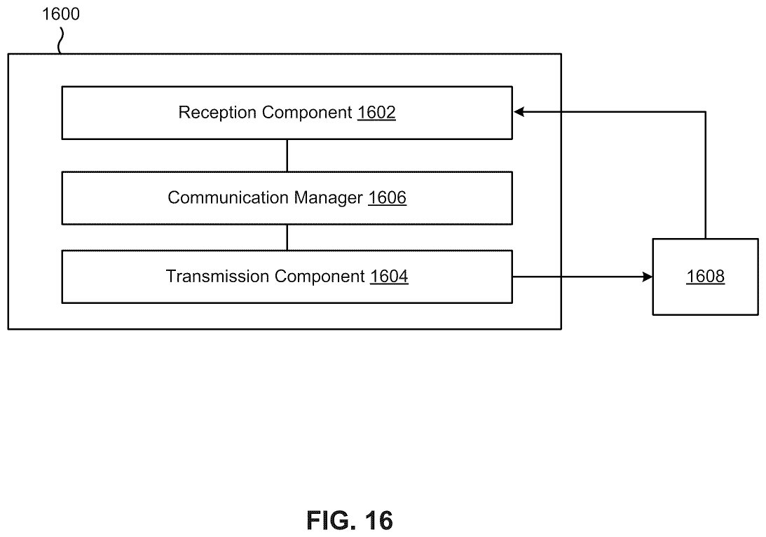

In some aspects, the UE includes means for receiving, from a network node, a configuration associated with an SRS for channel estimation associated with the UE, wherein the configuration indicates at least one report type associated with the SRS; or means for transmitting, to the network node, an SRS in accordance with a configuration associated with channel estimation, wherein the channel estimation includes at least one of a channel estimation for one or more SRS ports associated with the UE or a channel estimation for one or more logical ports associated with the UE in accordance with the at least one report type. The means for the UE to perform operations described herein may include, for example, one or more of communication manager 150, processing system 140, a radio, one or more RF chains, one or more transceivers, one or more antennas, one or more modems, a reception component (for example, reception component 1602 depicted and described in connection with FIG. 16), or a transmission component (for example, transmission component 1604 depicted and described in connection with FIG. 16), among other examples.

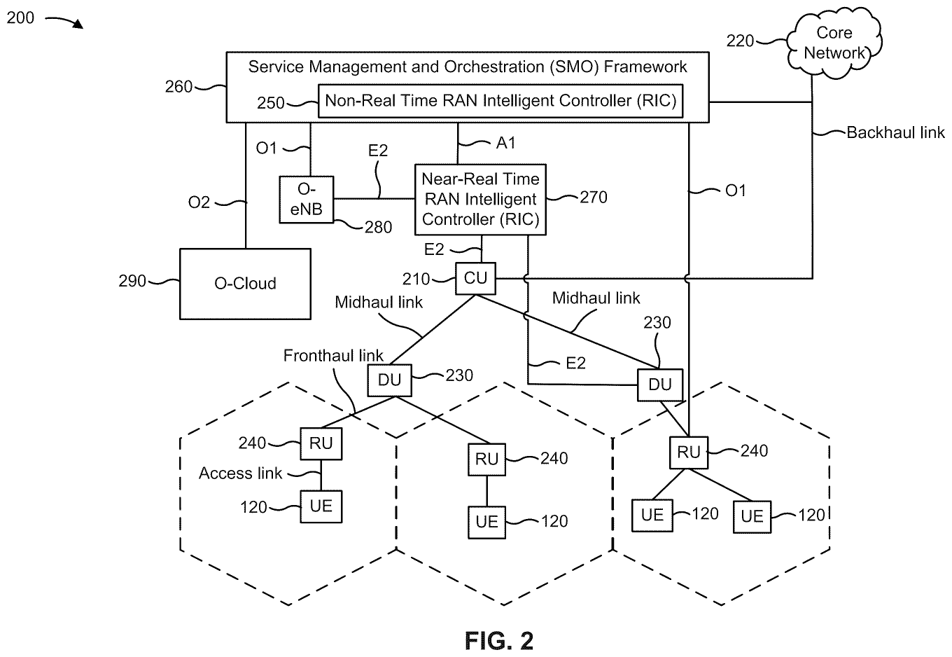

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium. In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270. In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

In some aspects, an RU 240 may be configured to support SRS beamforming techniques. For example, the RU 240 may be configured to support techniques for beamforming, channel estimation, and beam weight generation at the RU 240, while supporting the reporting of information associated with the SRS from the RU 240 to the DU 230. In some aspects, the RU 240 may receive a configuration from the DU 230 associated with transmission of reports associated with an SRS. In some cases, the RU 240 may be configured to report SRS channel estimation for SRS ports or logical ports. In some aspects, the RU 240 may select to report channel estimations based on context. For example, the RU 240 may report channel estimations for SRS ports when the report is associated with uplink scheduling, and channel estimations for logical ports may be reported when the report is associated with downlink scheduling. Additionally, or alternatively, the DU 230 may be configured to indicate a usage type for the SRS or a report type for the report, and the report may be in accordance with the indicated report type or usage type. In some aspects, the RU 240 may include a mapping that links a channel estimation for logical ports to a channel estimation for SRS ports. For example, the mapping may include a transformation matrix that may be used to convert the channel estimation for the logical ports to a channel estimation for the SRS ports. In some aspects, the RU 240 may be configured to combine an SRS channel estimation with ULPI channel estimation based on reception of a DMRS from the UE 120. For example, the SRS channel estimation and the ULPI channel estimation may be combined to improve channel estimation for one or more slots or to enhance calculation of second order statistics (e.g., a power delay profile, or a Doppler spread), or the SRS reception may be used as a spatial prefilter for reception of the DMRS.

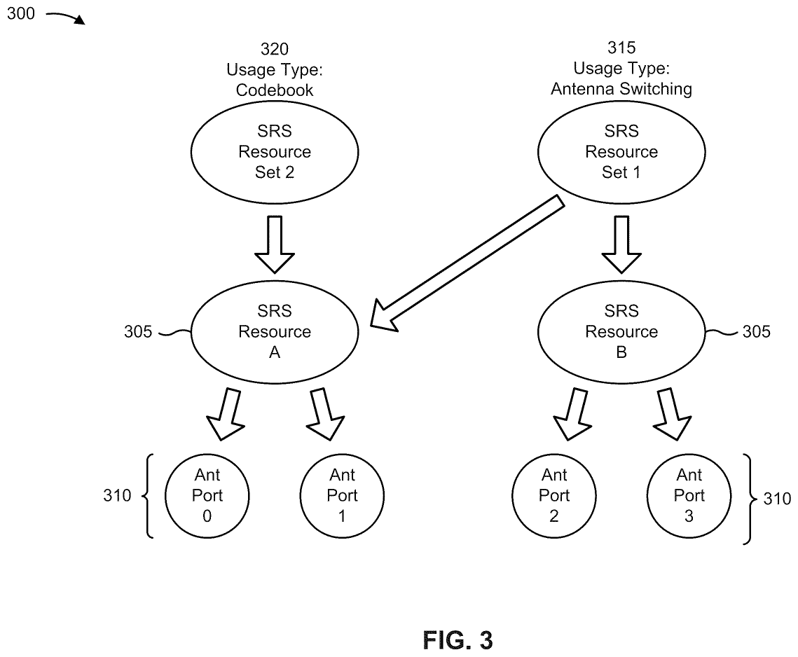

FIG. 3 is a diagram illustrating an example 300 of SRS resource sets.

A UE 120 may be configured with one or more SRS resource sets to allocate resources for SRS transmissions by the UE 120. For example, a configuration for SRS resource sets may be indicated in a radio resource control (RRC) message (e.g., an RRC configuration message or an RRC reconfiguration message). As shown by reference number 305, an SRS resource set may include one or more resources (e.g., shown as SRS resources), which may include time resources or frequency resources (e.g., a slot, a symbol, a resource block, or a periodicity for the time resources).

As shown by reference number 310, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a usage type (e.g., in an SRS-SetUse or Usage Type information element) for the SRS resource set. For example, an SRS resource set may have a usage type of antenna switching, codebook, non-codebook, or beam management.

An antenna switching SRS resource set may be used to indicate downlink CSI with reciprocity between an uplink and downlink channel. For example, when there is reciprocity between an uplink channel and a downlink channel, a network node 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a network node 110 indicates an uplink precoder to the UE 120. For example, when the network node 110 is configured to indicate an uplink precoder to the UE 120 (e.g., using a precoder codebook), the network node 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the network node 110). In some aspects, virtual ports (e.g., a combination of two or more antenna ports) with a maximum transmit power may be supported at least for a codebook SRS.

A non-codebook SRS resource set may be used to indicate uplink CSI when the UE 120 selects an uplink precoder (e.g., instead of the network node 110 indicated an uplink precoder to be used by the UE 120. For example, when the UE 120 is configured to select an uplink precoder, the network node 110 may use a non-codebook SRS (e.g., an SRS transmitted using a resource of a non-codebook SRS resource set) to acquire uplink CSI. In this case, the non-codebook SRS may be precoded using a precoder selected by the UE 120 (e.g., which may be indicated to the network node 110).

A beam management SRS resource set may be used for indicating CSI for millimeter wave communications. An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a MAC-CE). An aperiodic SRS resource may be triggered dynamically, such as via DCI (e.g., UE-specific DCI or group common DCI) or a MAC-CE.

In some aspects, the UE 120 may be configured with a mapping between SRS ports (e.g., antenna ports) and corresponding SRS resources. The UE 120 may transmit an SRS on an SRS resource using an SRS port indicated in the configuration. In some aspects, an SRS resource may span N adjacent symbols within a slot (e.g., where N equals 1, 2, or 4). The UE 120 may be configured with X SRS ports (e.g., where X≤4). In some aspects, each of the X SRS ports may mapped to a corresponding symbol of the SRS resource and used for transmission of an SRS in that symbol.

As shown in FIG. 3, in some aspects, different SRS resource sets indicated to the UE 120 (e.g., having different usage types) may overlap (e.g., in time or in frequency, such as in the same slot). For example, as shown by reference number 315, a first SRS resource set (e.g., shown as SRS Resource Set 1) is shown as having an antenna switching usage type. As shown, this example antenna switching SRS resource set includes a first SRS resource (shown as SRS Resource A) and a second SRS resource (shown as SRS Resource B). Thus, antenna switching SRS may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 320, a second SRS resource set (e.g., shown as SRS Resource Set 2) may be a codebook usage type. As shown, this example codebook SRS resource set includes only the first SRS resource (shown as SRS Resource A). Thus, codebook SRSs may be transmitted in SRS Resource A (e.g., the first time-frequency resource) using antenna port 0 and antenna port 1. In this case, the UE 120 may not transmit codebook SRSs in SRS Resource B (e.g., the second time-frequency resource) using antenna port 2 and antenna port 3.

In some aspects, an RU 240 may be configured to support SRS beamforming techniques. For example, the RU 240 may be configured to support techniques for beamforming, channel estimation, and beam weight generation at the RU 240, while supporting the reporting of information associated with the SRS from the RU 240 to the DU 230. In some aspects, the RU 240 may receive a configuration from the DU 230 associated with transmission of reports associated with an SRS. In some cases, the RU 240 may be configured to report SRS channel estimation for SRS ports or logical ports. In some aspects, the RU 240 may select to report channel estimations based on context. For example, the RU 240 may report channel estimations for SRS ports when the report is associated with uplink scheduling, and channel estimations for logical ports may be reported when the report is associated with downlink scheduling. Additionally, or alternatively, the DU 230 may be configured to indicate a usage type for the SRS or a report type for the report, and the report may be in accordance with the indicated report type or usage type. In some aspects, the RU 240 may include a mapping that links a channel estimation for logical ports to a channel estimation for SRS ports. For example, the mapping may include a transformation matrix that may be used to convert the channel estimation for the logical ports to a channel estimation for the SRS ports. In some aspects, the RU 240 may be configured to combine an SRS channel estimation with ULPI channel estimation based on reception of a DMRS from the UE 120. For example, the SRS channel estimation and the ULPI channel estimation may be combined to improve channel estimation for one or more slots or to enhance calculation of second order statistics (e.g., a power delay profile, or a Doppler spread), or the SRS reception may be used as a spatial prefilter for reception of the DMRS.

As indicated above, FIG. 3 is provided as an example. Other examples may differ from what is described with regard to FIG. 3.

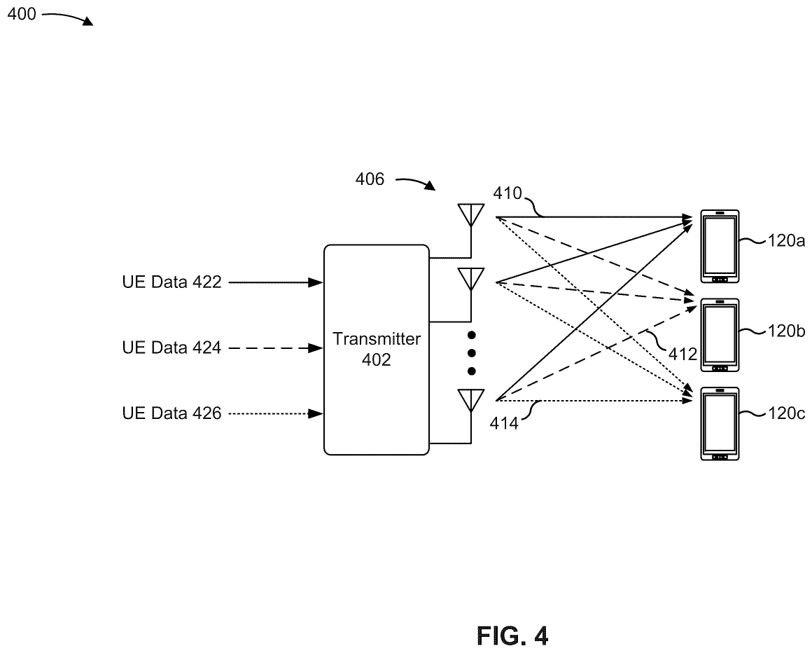

FIG. 4 is a diagram illustrating an example 400 of multiple user (MU)-MIMO.

In a MIMO system, the transmitter device 402 and receiver devices wirelessly communicate with one another based at least in part on multiple antennas. For example, the transmitter device 402 may include M antennas as shown by reference number 406, and a receiver device may include N antennas, where M and N are integers that may be equal or different from one another (e.g., M=N, M>N, or M<N).

In some examples, the transmitter device 402 may transmit multiple data streams via the M antennas based at least in part on using signal diversity, such as spatial diversity or polarization diversity. Typically, the number of data streams transmitted by a transmitter device is fewer than a number of antennas. That is, the mapping of the number of data streams to the number of antennas is not 1:1. Rather, each stream may be mapped with a unique set of weights to all of the available antenna such that all of the available antennas are used to transmit the multiple data streams. For example, the transmitter device 402 may transmit a first data stream 410 (shown with a solid line) using all of the M antennas and a first set of precoding weights. The first data stream 410 may include first UE data. Accordingly, each antenna of the M antenna may transmit a respective signal that carries the first data stream, and the respective signal may be precoded using a beam weight in the first set of precoding weights. Additionally, or alternatively, the transmitter device 402 may transmit a second data stream 412 (shown with a dashed line) using all of the M antennas and a second set of precoding weights, or a third data stream 414 (shown with a dotted line) using all of the M antennas and a third set of precoding weights. The second data stream 412 may include second UE data and the third data stream 414 may include third UE data. Other examples may include the transmitter device 402 transmitting each data stream using a respective subset of antennas of the M antennas. “Analog beamforming” may denote signal manipulation (e.g., the application of precoding weights) in an analog domain or an RF domain, and “digital beamforming” may denote signal manipulation in a digital domain. A transmitter device (e.g., the transmitter device 402) may perform beamforming using analog beamforming, digital beamforming, or a combination of analog beamforming and digital beamforming.

“Spatial diversity” may denote spatially diverse signal transmissions. To illustrate, and as described above, the transmitter device 402 may apply precoding to multiple signals that, when summed together, form a first beam at a first carrier frequency, where the first beam propagates in a first direction with a first spatial beamwidth. For example, the precoding may adjust respective phases or amplitudes of two or more signals that are transmitted by two or more antennas to constructively form the first beam, and the first beam may carry a first data stream. Alternatively, or additionally, the transmitter device 402 may apply precoding to multiple signals that, when summed together, form a second beam at a second carrier frequency (e.g., that may be the same carrier frequency as the first carrier frequency or a different carrier frequency from the first carrier frequency) that propagates in a second direction with a second spatial beamwidth. In some aspects, the second beam may carry a second data stream that is different from the first data stream. The transmitter device 402 may select the second propagation direction or the second spatial beamwidth to mitigate or avoid overlap with the first propagation direction or the first spatial beamwidth. That is, the first beam and the second beam may be spatially diverse based at least in part on propagating in non-overlapping directions with non-overlapping spatial beamwidths (or partially overlapping directions or spatial beamwidths).

“Polarization diversity” may denote at least two signals that have diverse polarizations. As one example, an electromagnetic (EM) wave may include an electric field (E-field) and magnetic field (H-field) that propagate along a same propagation line (e.g., a same direction) and are perpendicular to one another. For example, in an XYZ coordinate system that is characterized by an X-plane, a Y-plane, and a Z-plane that are perpendicular to one another, the E-field of the EM wave is separated from the H-field by 90 degrees. Accordingly, if an E-field that propagates along an X-axis with an amplitude that varies along the Y-axis (e.g., within a horizontal X-Y plane), the H-field may also propagate along the X-axis with an amplitude that varies along the Z-axis (e.g., in a perpendicular, vertical X-Z plane). In linear polarization, the E-field and the H-field may propagate without rotating around the propagation line, while in circular polarization, the E-field and the H-field may rotate around the propagation line. In some aspects, the transmitter device 402 may transmit a first signal that is based at least in part on a first carrier frequency and a first polarization. Alternatively, or additionally, the transmitter device 402 may transmit a second signal that is based at least in part on a second carrier frequency (e.g., that may be the same carrier frequency as the first carrier frequency or a different carrier frequency from the first carrier frequency) and a second polarization that is orthogonal to the first polarization. That is, the first signal and the second signal may have diverse polarizations. For example, the E-field of the first signal is orthogonal to the E-field of the second signal, and the H-field of the first signal is orthogonal to the H-field of the second signal. In some aspects, the first signal may carry first data, and the second signal may carry second data that is different from the first data. To illustrate, the transmitter device 402 may include at least a first antenna that is configured to generate a first signal that has a first polarization and a second antenna that is configured to generate a second signal that has a second polarization.

While the above example describes polarizations with respect to orthogonal E-fields and orthogonal H-fields, other examples may use polarizations that are sufficiently decorrelated. For instance, two polarizations may be a complex weighted combination of E-field and H-field polarizations. As another example, the two polarizations may be based at least in part on a polarization distribution of the antenna elements in an antenna array. With enough decorrelation between polarizations, same or different spatial directions (e.g., transmit antenna weights), and same or different frequencies may be used for two transmission paths.

The demand for services provided by a wireless network continues to increase as more and more devices access the wireless network. A MIMO system may, in some cases, meet the demand based at least in part on the ability to simultaneously or contemporaneously transmit multiple data streams. To illustrate, and as described above, the use of multiple antennas in a MIMO system allows a transmitter device to simultaneously or contemporaneously transmit the multiple data streams using different paths (e.g., different spatial paths or different polarization paths), resulting in increased data throughput based at least in part on transmitting multiple data streams using diverse signals.

In a MU-MIMO system, the transmitter device 402 (e.g., a network node 110) may simultaneously serve multiple receiving devices (shown as a first UE 120a, a second UE 120b, and a third UE 120c as an example) based at least in part on beamforming, spatial diversity (e.g., spatial multiplexing), or polarization diversity (e.g., polar multiplexing). For instance, the transmitter device may simultaneously serve a first UE 120a, a second UE 120b, and a third UE 120c using MU-MIMO communications. For example, the transmitter device 402 may transmit first UE data 422 via the first data stream 410 (shown with a solid line) that is associated with the first UE 120a using a first beam, second UE data 424 via the second data stream 412 (shown with a dashed line) that is associated with the second UE 120b using a second beam, and third UE data 426 via the third data stream 414 (shown with a dotted line) that is associated with the third UE 120c using a third beam. The transmitter device 402 may form the first beam by applying first precoding to multiple signals (illustrated in FIG. 4 with solid lines) that, when summed together, form the first beam. In a similar manner, the transmitter device 402 may form the second beam by applying second precoding to multiple signals (illustrated in FIG. 4 with dashed lines), and may form the third beam by applying third precoding to multiple signals (illustrated in FIG. 4 with dotted lines). The multiple signals that form the first beam, the multiple signals that form the second beam, and the multiple signals that form the third beam may be simultaneously emitted by one or more of the multiple antennas shown by reference number 406. The first beam, the second beam, and the third beam may use different carrier frequencies, may use a same carrier frequency, may use different air interface resources, or may use a same air interface resource. The first UE 120a, the second UE 120b, and the third UE 120c may include, respectively, a single antenna port or multiple antenna ports, and each antenna port may be associated with one or more antennas of the respective UE. The simultaneous transmissions to respective devices (e.g., UEs in the example 400) may alternatively be referred to as MU-MIMO communications.

A network node may select or group UEs for MU-MIMO communications in a same time partition (e.g., a slot) based at least in part on a variety of factors that may affect MU-MIMO performance (e.g., increase or decrease data throughput). For example, the network node may select UEs based at least in part on UE location or beams that are used to communicate with the UEs. For example, the network node may select or group UEs that are associated with different beams, beams that have low correlation, or beams that have high spatial diversity. As another example, the network node may select or group UEs based at least in part on one or more signal quality metrics, such as by grouping UEs that are associated with CQI metrics that satisfy a CQI threshold or UEs that are associated with sounding reference signal (SRS) signal-to-interference-plus-noise ratio (SINR) metrics that satisfy an SRS SINR threshold. Alternatively, or additionally, the network node may enable or disable MU-MIMO communications based on a variety of factors that affect MU-MIMO performance, such as a number of UEs served by the network node, a traffic load of the network node, a scatter distribution in a cell provided by the network node, or a UE distribution (e.g., location distribution) in the cell provided by the network node.

In some aspects, an RU 240 (which may be an example of the transmitter 402) may be configured to support SRS beamforming techniques. For example, the RU 240 may be configured to support techniques for beamforming, channel estimation, and beam weight generation at the RU 240, while supporting the reporting of information associated with the SRS from the RU 240 to the DU 230. In some aspects, the RU 240 may receive a configuration from the DU 230 associated with transmission of reports associated with an SRS. In some cases, the RU 240 may be configured to report SRS channel estimation for SRS ports or logical ports. In some aspects, the RU 240 may select to report channel estimations based on context. For example, the RU 240 may report channel estimations for SRS ports when the report is associated with uplink scheduling, and channel estimations for logical ports may be reported when the report is associated with downlink scheduling. Additionally, or alternatively, the DU 230 may be configured to indicate a usage type for the SRS or a report type for the report, and the report may be in accordance with the indicated report type or usage type. In some aspects, the RU 240 may include a mapping that links a channel estimation for logical ports to a channel estimation for SRS ports. For example, the mapping may include a transformation matrix that may be used to convert the channel estimation for the logical ports to a channel estimation for the SRS ports. In some aspects, the RU 240 may be configured to combine an SRS channel estimation with ULPI channel estimation based on reception of a DMRS from the UE 120. For example, the SRS channel estimation and the ULPI channel estimation may be combined to improve channel estimation for one or more slots or to enhance calculation of second order statistics (e.g., a power delay profile, or a Doppler spread), or the SRS reception may be used as a spatial prefilter for reception of the DMRS.

In some aspects, an RU 240 may be configured to support SRS beamforming in accordance with MU-MIMO techniques. For example, the RU 240 may be configured to support techniques for beamforming, channel estimation, and beam weight generation for multiple UEs 120 simultaneously. In some aspects, the RU 240 may receive a configuration from the DU 230 associated with the transmission of reports and beamforming weights for multiple UEs 120. The RU 240 may be configured to handle the spatial multiplexing of signals, ensuring that the signals intended for different UEs 120 do not interfere with each other.

In some aspects, an RU 240 may be configured to support various SRS use cases, including antenna switch, codebook-based, non-codebook-based, beam management, and positioning. For example, the RU 240 may be configured to support techniques for beamforming, channel estimation, and beam weight generation based on different SRS use cases. The RU 240 may receive a configuration from the DU 230 associated with the transmission of reports and beamforming weights for multiple UEs 120, ensuring that the signals intended for different UEs 120 do not interfere with each other.

In some aspects, the RU 240 may be configured to generate uplink beamforming weights based on SRSs transmitted by multiple UEs 120. The RU 240 may receive SRSs from the multiple UEs 120 and use these signals to estimate the uplink channel conditions for each UE 120. The RU 240 may then generate beamforming weights that optimize the reception of signals from each UE 120, taking into account the spatial characteristics of the channel. The RU 240 may report these channel estimations and beamforming weights to the DU 230, which may use the reported information for scheduling and further optimization.

The RU 240 may support different report types depending on a usage type (e.g., a use case) associated with the SRS or the report. For example, the RU 240 may report an SRS signal-to-noise ratio (SNR). In some examples, for antenna switch usage types, the RU 240 may perform singular value decomposition (SVD) channel abstraction, and the RU 240 may report one or more matrices, such as a U, an S, and a V matrix. In some cases, the U matrix may represent the mapping between baseband ports and UE 120 receive ports, the S matrix may represent the singular values, and the V matrix may represent the mapping between UE 120 receive ports. In some examples, for codebook and non-codebook-based usage types, the RU 240 may report channel estimates per SRS port.

In some examples, a frequency resolution of the reports may be sub-sampled over multiple physical resource blocks (PRBs). In some cases, a MAC layer (e.g., a DU 230) may be used to indicate the PRB sub-sampling for the report to the RU 240, which may be based on a capability associated with the RU 240 layer. In some examples, a reporting flag may be used (e.g., by the DU 230) to indicate to the RU 240 whether a report is required, and not every SRS resource may result in a report being transmitted from the RU 240 to the DU 230. For example, a report may only be generated when all ports have been sampled (e.g., in the antenna-switch usage type).

In some aspects, the RU 240 may be configured to handle incomplete sampling of UE 120 ports or situations where a Layer 2 (L2) (e.g., a MAC layer) reporting capability exceeds an L1 (e.g., a PHY layer) reporting capability. For example, in such cases, the RU 240 (e.g., the PHY layer, or a lower PHY layer) may indicate to the DU 230 (e.g., the MAC layer, or an upper PHY layer) that no new report is available. In some examples, an SRS physical data unit (PDU) (e.g., an SRS configuration or a message associated with the SRS) may correspond to a resource configuration, such that the RU 240 and the DU 230 may maintain a consistent understanding of which receive or transmit ports are being sounded in each resource. Additionally, or alternatively, the RU 240 may indicate receive (e.g., for antenna-switch SRS) or transmit (e.g., for codebook or non-codebook SRS) ports being sounded by each SRS resource. Additionally, or alternatively, the RU 240 and the DU 230 may exchange information associated with one or more UE 120 antennas and one or more SRS sounded antennas. The information may include a bitmap from L2 to L1, and the bitmap may indicate that the antennas are sounded by an SRS resource for the direction being sampled for the SRS. In the antenna switch use case, a message (e.g., an SRS PDU) from the DU 230 to the RU 240 may allow the RU 240 to determine when sampling is completed for all receive ports and across all frequency hops, enabling the RU 240 to compute the SVD representation.

In some aspects, the RU 240 may be configured to report information to the DU 230 to support downlink scheduling. In some examples, the RU 240 may handle MU-MIMO grouping and layer selection based on one or more configurations received from the DU 230. For example, for CSI-based MIMO, layer selection may use explicit semi-statically-configured beamforming and precoder weights based on CSI reports. Additionally, or alternatively, for reciprocity-based MIMO, the precoders may be computed by the RU 240 (e.g., by the PHY layer) based on SRS channel estimates. The RU 240 may report the channel estimations and the corresponding SVD eigenvalues to the DU 230, enabling the MAC and PHY layers to have a common understanding of which eigenvalues are mapped to which layers for each UE 120, and the DU 230 may compute the corresponding precoders accordingly. In some examples, for downlink reciprocity-based MIMO, the DU 230 may designate the scheduled layers, in accordance with a per-precoding resource group (PRG) resolution, based on the SVD report from the RU 240.

Additionally, or alternatively, the RU 240 may be configured to support reporting information to the DU 230 to facilitate uplink scheduling. In some examples, the RU 240 may handle MU-MIMO grouping and layer indication based on one or more configurations received from the DU 230. In some examples, such as for reciprocity-based UL-MIMO decoding, layers may be extracted from DMRS reception (e.g., from a DMRS received from the UE 120 by the RU 240). In some cases, sharing information associated with the UL layers between the RU 240 and the DU 230 may enable the RU 240 to form combinations prior to a processing of the DMRS.

In some examples, the RU 240 may report the channel estimations and a corresponding SRS reference indicator (SRI) or combinations of transmission PMIs (TPMIs) and SRIs to the DU 230. Accordingly, the MAC and PHY layers may have a common understanding of which SRIs or SRI and TPMI combinations are mapped to which layers for each UE 120. In some examples, such as for uplink MIMO techniques, the DU 230 may designate the scheduled layers, in accordance with a per-PRG resolution, based on the SRS channel estimation reports from the RU 240.

In some aspects, the RU 240 may be configured to support precoding and beamforming in accordance with one or more look-up tables (LUTs). For example, the RU 240 may receive an indication of CSI from the DU 230, enabling the RU 240 to select appropriate precoders and beams via integer indices in accordance with the LUTs. In some aspects, the RU 240 may also support generalized spatial multiplexing, and the RU 240 may perform channel abstraction based on the SRS and report related information to the DU 230. The DU 230 may select UE 120 layers at a PRG resolution and perform scheduling for the UE 120. In some examples, the RU 240 may compute dynamic precoders based on the selected UEs 120 and layers and the stored channel estimates.

In some examples, the DU 230 may receive an indication of limitations associated with a quantity of layers or precoders supported by the RU 240. The DU 230 may multiplex layers from different channels onto available ports. For example, spatially division multiplexed layers may use different ports, while frequency-division multiplexed or time-division multiplexed layers from different channels may be configured to share a port.

In some examples, to avoid ambiguity and support improved layer-to-port mapping, the DU 230 may indicate explicit layer-to-port mappings to the RU 240. Additionally, or alternatively, for the PDCCH, single layers may be assigned explicit port indices. For CSI-RS, ports in each code division multiplexing (CDM) group may be explicitly assigned port indices. In some examples, the DU 230 may allocate port indices ranging from 0 to the maximum number of ports supported by the RU 240. The RU 240 may rely on the assigned port indices to avoid exceeding hardware limits of the RU 240 associated with the quantity of ports.

In some examples, the RU 240 may be configured to support uplink digital precoding architecture. Similar to downlink operations, the RU 240 may use one or more LUTs for digital beamforming, where the LUTs may store precoder and beamforming information. The RU 240 may receive CSI from the DU 230 that may be used by the RU 240 to select appropriate beams via the LUTs. In some examples, the RU 240 may support generalized spatial multiplexing for uplink operations. The RU 240 may perform channel abstraction based on SRS and report this information to the DU 230. The DU 230 may then select UEs 120 and layers at PRG resolution and schedule them accordingly. For codebook-based layers, the selection may include one or more SRIs, TPMIs, or a combination thereof, and for non-codebook-based layers, the selection may involve SRIs. The RU 240 may compute precoders based on UE 120 layers and the stored channel estimates.

Accordingly, the flexibility and reporting techniques supported by the RU 240 may allow the RU 240 and the DU 230 to adapt to changing channel conditions and usage scenarios, while supporting scheduling at the DU 230.

As indicated above, FIG. 4 is provided as an example. Other examples may differ from what is described with regard to FIG. 4.

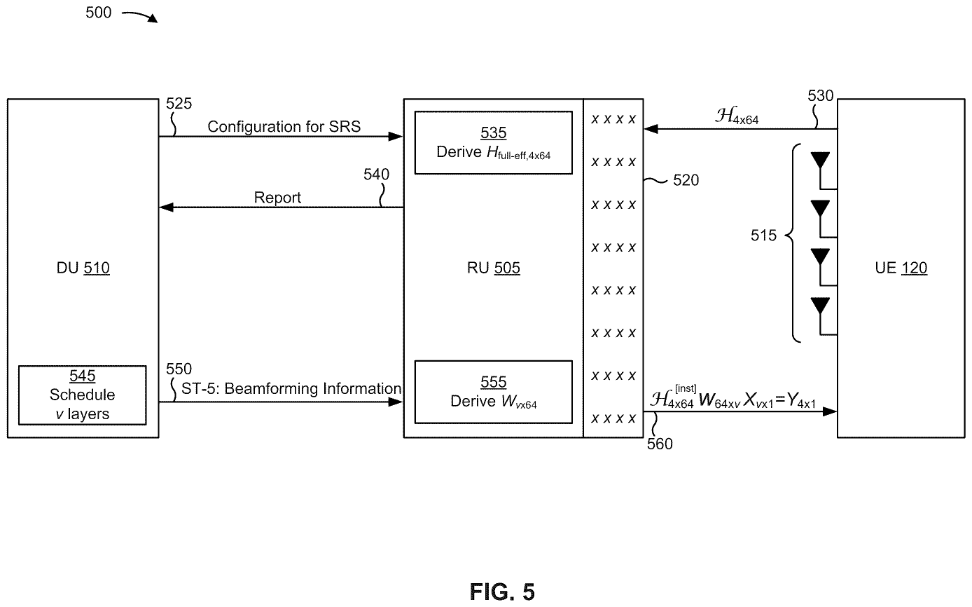

FIG. 5 illustrates an example 500 associated with SRS based beamforming at an RU 505. The example 500 illustrates communications between the RU 505 (e.g., an RU 240, as described herein), a UE 120, and a DU 510 (e.g., a DU 230, as described herein). In some examples, communications between the RU 505 and the DU 510 may be performed via a fronthaul link, as described herein. In some aspects, the UE 120 may transmit or receive messages to the RU 505 via a set of one or more antennas 515. Additionally, the RU 505 may transmit or receive messages to the UE 120 via a set of antennas 520.

In some aspects, the RU 505 may be configured to receive a configuration 525 associated with SRS reporting from the DU 510. In some aspects, the configuration 525 may be received via a first section type (ST) message (e.g., ST-X, where X may be a first integer). The configuration 525 may provide the RU 505 with information regarding a type of measurement or report for RU to perform or signal at a later time, at least some of which is associated with the SRS Accordingly, the configuration may enable the RU 505 to receive the SRS 530 and perform beamforming and channel estimation, and the RU 505 may issue one or more measurements that may reflect at least one of beamforming and channel estimation.

In some aspects, the configuration may indicate one or more usage types for the SRS waveform, allowing the RU 505 to issue usage-specific reports. In some examples, the usage-specific reports may be linked to requests by the DU 510 of one or more reports having one or more usage types. Additionally, or alternatively, the report types may be selected in accordance with logical port identifiers (which may be indicated by one or more UE identifiers (UEIDs)) or SRS port identifiers (e.g., srsPortIDs) indicated by the configuration, or the report types may be indicated per specific report instance.

In some aspects, the configuration may be in accordance with a capability of the RU 505. For example, the RU 505 may support one or more report types, beamforming types, or port types. For instance, the RU 505 may support a “type S” for channel estimation or for beamforming, and the type S may correspond to channel estimation for SRS ports or beamforming applied to SRS ports. Additionally, or alternatively, the RU 505 may support a “type L” for channel estimation or for beamforming, and the type L may correspond to channel estimation for logical ports or beamforming applied to logical ports. The support for different report types, beamforming types, or port types may be specified per endpoint, per RU 505, or per endpoint group. Additionally, or alternatively, combinations of report and beamforming types that are supported by the RU 505 may be defined (e.g., in a specification), such as by specifying that all downlink reporting and beamforming corresponds to the type L and all uplink reporting and beamforming corresponds to the type S. Additionally, or alternatively, type combinations may be allowed, such that some report types may be for either logical ports, SRS ports, or both. In some cases, when a configured report type supports either SRS ports or logical ports, the RU 505 may be configured to report a mapping (e.g., a conversion matrix) between different port types, as described herein.

For example, in some aspects, the RU 505 may transmit, to the DU 510, capability information. The capability information may include information associated with a grouping of one or more UE ports (e.g., SRS ports, logical ports, or other ports) for the UE 120. The RU 505 may receive, from the DU 510, an indication of the grouping of the one or more UE ports based on the capability information. In some aspects, the DU 510 may indicate that the grouping is associated with a downlink transmission associated with the UE 120. In some aspects, the DU 510 may indicate that the grouping includes at least one UE port of the one or more UE ports for channel estimation to be derived from the SRS 530. Additionally, or alternatively, the RU 505 may select UE ports (e.g., logical ports) based on SINR values associated with the UE ports, degree of closeness (e.g. correlation) between UE ports, or other criteria for UE port selection. For example, the RU 505 may select one or more UE ports associated with highest SINR values relative to all UE ports of a set of UE ports. In some aspects, such as when supporting MU-MIMO techniques, the DU 510 may include information for the RU 505 to down-select UE ports for the downlink transmission.

In some aspects, ports from multiple UEs may be associated with the signaling. In some aspects, the signaling pertaining port selection and group employs signaling. In some aspects, logical ports may be identified with layers. Additionally, or alternatively, logical ports may be identified with pilot ports. For example, pilot ports may correspond to SRSs.

The RU 505 may receive the SRS 530 from the UE 120, and a channel associated with the SRS 530 may be represented by H_{4×64} (e.g., in the case where the UE 120 includes four antennas, as depicted in FIG. 5). In some examples, the SRS 530 may be associated with a usage type corresponding to downlink beamforming (e.g., downlink channel estimation). In an operation 535, the RU 505 may be configured to derive (e.g., estimate) an effective channel in accordance with the SRS 530 transmitted by the UE 120, and the effective channel may be represented by H_{full_eff,4×64}, alternatively referred to as H_{ST6-eff,4×64}.

In some aspects, the RU 505 may use SRS-based and DMRS-based channel estimates as priors for each other. In some cases, the DU 510 may allow or disallow whether SRS and DMRS channel estimates may be combined via an indication of one or more flags. For example, the DU 510 may signal how SRS and DMRS channel estimates may be used together, such as by using them together with TPMI to improve channel estimates within the same slot, using SRS as a spatial prefilter for DMRS, or enhancing second order statistics like Doppler spread and a power delay profile (PDP).

For example, the RU 505 may be configured to derive the effective channel by linking ULPI channel estimates (e.g., based on DMRS reception from the UE 120) and SRS channel estimates. The linking may be achieved using the same logical channel identifiers, such as UEIDs, where the context determines whether to perform channel estimation for SRS ports or logical ports, as described herein. Alternatively, the linking may be identified by UE identifiers, such as a radio network temporary identifier (RNTI) portion of a UE identifier. In some aspects, the linkage may be further enhanced by the DU 510 signaling to the RU 505 the precoding used by the UE 120 on SRS ports for the SRS 630 transmission. In some examples, the RU 505 may declare (e.g., signal to the DU 510) different ULPI capabilities based on the ULPI and SRS linking. For example, when SRS prefiltering is used, the RU 505 may support more ULPI layers than when SRS prefiltering is not used. In some examples, the linking of the ULPI channel estimates and the SRS channel estimates may be signaled via the configuration 525.

In some aspects, the RU 505 may be configured to transmit a report 540 to the DU 510, and the report 540 may provide information for downlink scheduling. In some examples, the report 540 may be an example of a second ST message (e.g., ST-Y, where Y may be a second integer). The report 540 may include channel estimates for SRS ports or logical ports, ensuring that the DU 510 has sufficient information to derive critical parameters such as a TPMI for the UE 120. In some aspects, the report 540 may include a mapping between channel estimates for logical ports and channel estimates for SRS ports. In some aspects, the report 540 may include an indication of the effective channel (e.g., H_{ST6_eff,4×64}), an antenna-domain DFT of the effective channel, an eigenvalue decomposition (EVD) associated with the effective channel for each antenna port associated with the UE 120

$$( e . g . , {EVDH}_{ST \_ eff , i \times 64} * {H}_{ST 6 \_ eff , i \times 64}^{H} ,$$

for all i, which for four antennas may be integer values between 1 and 4).

Additionally, or alternatively, the report 540 may also include channel estimates for SRS ports when the DU 510 requests such estimates. Accordingly, the DU 510 may directly utilize the SRS port channel information for scheduling. In some aspects, an identifier other than a UEID (e.g., used for logical ports) may be used for reporting SRS port channel information. Additionally, in some aspects, the RU 505 may include a delay or scope of SRS ports needed for logical channel reporting in the report 540. In some examples, the report 540 may be sent after all SRS ports have been sampled. Additionally, or alternatively, multiple individual reports 540 may be issued for each individual SRS port. Additionally, or alternatively, multiple individual reports 540 may be sent after each of one or more groupings of SRS ports has been sampled, where each grouping may be linked to slots, coherence groups, or other parameters associated with the SRS ports.

In some aspects, a triggering of sending the report 540, or a triggering of a recalculation of channel estimates (e.g., for logical ports), may be performed implicitly at the RU 505. For example, the RU 505 may transmit the report 540 or perform a recalculation of channel estimates for logical ports (e.g., without obtaining a command from the DU 510) after all relevant SRS ports needed for the reports have been sampled. Additionally, or alternatively, the triggering of the report 540 transmission or the recalculation may be performed explicitly. For example, the DU 510 may signal a command or message to trigger transmission of the report 540 by the RU 505.

In some aspects, the report 540 may include a mapping between channel estimates between SRS ports and logical ports. In some examples, the mapping may be a transformation matrix T, or a derived sufficient signaling thereof (e.g. inverse, complex conjugate, or a prestored index for the transformation matrix). Accordingly, the mapping may allow for an overloading case, where multiple purposes for the SRS waveform are supported (e.g., uplink and downlink). Additionally, or alternatively, the mapping may include mapping weights, at least one of which being different from a unit weight or a zero weight. Additionally, or alternatively, the mapping may be a linear transformation (e.g., with quantized weights).

In some aspects, different reports 540 may use the same or different identifiers to identify ports (e.g., logical ports or SRS ports). Additionally, or alternatively, the same port identifiers may be used for different purposes. For example, UEIDs may be used to identify either logical ports or SRS ports. In some aspects, when port identifiers are used for different purposes, ports identified by the port identifiers may be distinguished by context or associated purpose. For example, a report type configured for a report (e.g., as an SVD report, logical channel report, or TPMI report) may indicate whether the port identifiers correspond to SRS ports or logical ports. Additionally, or alternatively, a usage type configured for the SRS may indicate whether the port identifiers correspond to SRS ports or logical ports (e.g., usage types associated with uplink scheduling may correspond to SRS ports being indicated, and usage types associated with downlink scheduling may correspond to logical ports being indicated).

In some aspects, in an operation 545, the DU 510 may perform scheduling for the UE 120. For example, the DU 510 may schedule v layers for a downlink transmission for the UE 120. In some aspects, the scheduling may be performed in accordance with the report 540. For example, the scheduling may be performed in accordance with the effective channel, the antenna-domain DFT, the EVD associated with the effective channel, or other information included in the report 540. In some aspects, the scheduling may be performed for one or more ports, such as ports corresponding to a first identifier (e.g., UEID₁) to a v^{th} identifier (e.g., UEIDᵥ) in accordance with the v layers.

In some aspects, the DU 510 may send, to the RU 505, a message 550 that may include information for the RU 505 to perform beamforming. For example, the message 550 may include information for beamforming associated with downlink beams for communications with the UE 120. In some examples, the message 550 may be a third ST message (e.g., ST-5) or a similar message type, and the message 550 may include one or more fields that may specify a beamforming type, a corresponding port type (e.g., SRS ports or logical ports), or a combination thereof. In some examples, DU 510 may convey sufficient UE scheduling information to better narrow down an SRS steering subspace where an SRS 530 transmitted by the UE 120 is likely to be found. For example, the DU 510 may supply, via the configuration, a TPMI associated with the SRS 530. Additionally, or alternatively, the configuration may include one or more scheduling restrictions or assumptions associated with the SRS 530. In some aspects, the message 550 may indicate a linking of the ULPI channel estimates and the SRS channel estimates, which may be used by the RU 505 to perform beamforming.

Additionally, or alternatively, the message 550 may include information associated with performing a port conversion (e.g., between logical ports and SRS ports). For example, the message 550 may include an indication of a conversion matrix. Additionally, or alternatively, the message 550 may include an indication of a PMI, such as via a TPMI, which may facilitate the conversion between SRS ports and logical ports.

Additionally, or alternatively, the RU 505 may determine a conversion between SRS ports and logical ports independently. In some aspects, the RU 505 may determine the conversion in accordance with one or more restrictions on power levels or port combining methods associated with the RU 505 (e.g., configured to the RU 505, such as via the configuration 525 or the message 550). In some examples, the RU 505 may report the selected conversion back to the DU 510 (e.g., via an additional message), which may support synchronization between the DU 510 and the RU 505 in accordance with a selected beamforming configuration. In some aspects, the message 550 may include port identifiers corresponding to different ports, and the RU 505 may distinguish between different port types that the port identifiers apply to in accordance with a context or usage type associated with the SRS 530. For example, the usage type configured for the SRS 530 may indicate whether the port identifiers correspond to SRS ports or logical ports, and the RU 505 may interpret the beamforming information for downlink transmissions to the UE 120 accordingly.

In some aspects, in an operation 555, the RU 505 may derive one or more precoders (e.g., a precoding matrix W_{v×64}, where v is a quantity of layers scheduled for a downlink transmission) for downlink beamforming. The precoders may be derived in accordance with the beamforming information received from the DU 510. In some examples, the RU 505 may use the derived channel estimation to determine an appropriate precoding matrix. In some examples, the RU 505 may apply a pseudo-inverse or a zero-forcing regularization technique to the effective channel to obtain the precoding matrix. Additionally, or alternatively, the RU 505 may consider factors such as power restrictions or port combining methods when deriving the precoders. In some aspects, the RU 505 may report the derived precoders, the precoding matrix, or a transformation matrix (e.g., T) used in the derivation to the DU 510 in an additional message.

In some aspects, the DU 510 may signal (e.g., via a DL_TTI request) the RU 505 to initiate layer selection for downlink beamforming. In some examples, such as for CSI-based MIMO, layer selection may use explicit semi-statically-configured beamforming and precoder weights based on CSI reports received from the UE 120. Additionally, or alternatively, such as for reciprocity-based MIMO, the precoders may be computed by the RU 505 layer in accordance with the SRS channel estimates. In some aspects, the DU 510 and the RU 505 may exchange signaling associated with SVD eigenvalues that are used by the DU 510 to map layers for the UE 120, which may allow the RU 505 to compute the precoders in accordance with the eigenvalues.

In some aspects, MU-MIMO groups may be employed per slot, and the MU-MIMO groups may serve as a unit for precoder computation. For example, the DU 510 may form one or more MU-MIMO groups in accordance with one or more criteria, such as whether at least one tuple associated with an RB and symbol pair associated with a PDSCH PDU is common to other PDSCH PDUs, and the MU-MIMO grouping may be formed in accordance with the PDUs having the tuple in common. In some examples, RB and symbol tuples, where at least two layers (from the same or different UEs) are spatially multiplexed, may belong to one grouping and be allocated to all PDSCHs in the group. In some examples, the DU 510 may signal the MU-MIMO grouping to the RU 505, and the DU 510 may indicate a bitmap of RBs and symbols common to all allocations in the group.

In some aspects, the RU 505 may be configured to transmit a downlink message 560 (e.g., a PDSCH message) to the UE 120 in accordance with the beamforming. For example, the downlink message 560 may be transmitted in accordance with the precoders derived in the operation 555, and the RU 505 may use the precoding matrix W_{v×64} to apply precoding to the downlink transmission, ensuring that the signal is directed accurately toward the UE 120. For example, the downlink message 560 may be represented by Equation 1 below:

$${ℋ}_{4 \times 64}^{[ inst ]} {W}_{64 \times v} {X}_{v \times 1} = {Y}_{4 \times 1} \qquad ( 1 )$$

where

$${ℋ}_{4 \times 64}^{[ inst ]}$$

represents an instantaneous channel between the UE 120 and the RU 505, W_{64×v} represents the precoders applied by the RU 505, X_{v×1} represents the data intended for the UE 120, and Y_{4×1} represents transmitted signal to be received by the UE 120. In some examples, O-RU 505 may employ beamforming to enact the precoder rows.

As indicated above, FIG. 5 is provided as an example. Other examples may differ from what is described with regard to FIG. 5.

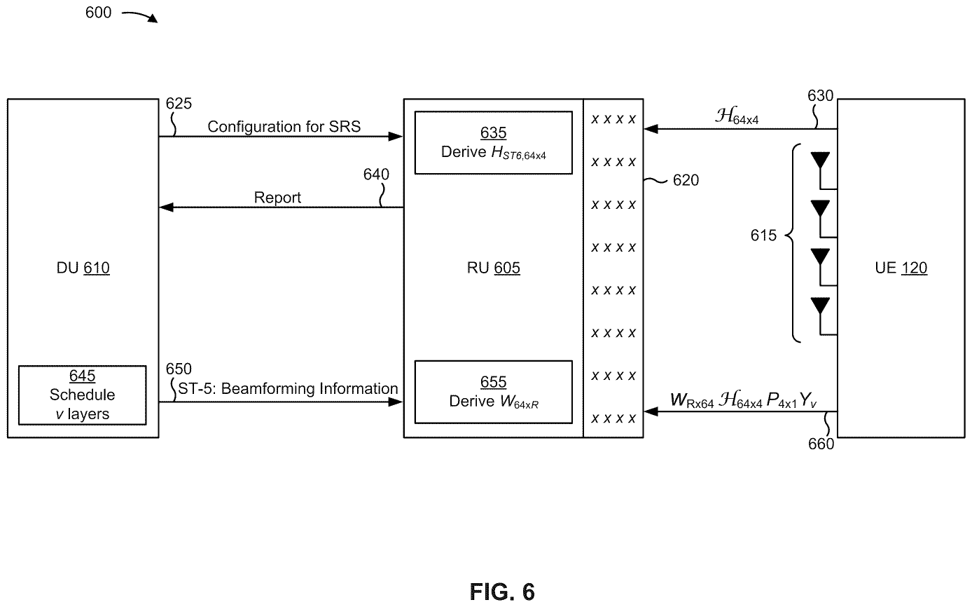

FIG. 6 illustrates an example 600 associated with SRS based beamforming at an RU 605. The example 600 illustrates communications between the RU 605 (e.g., an RU 240 or an RU 505, as described herein), a UE 120, and a DU 610 (e.g., a DU 230 or a DU 610, as described herein). In some examples, communications between the RU 605 and the DU 610 may be performed via a fronthaul link, as described herein. In some aspects, the UE 120 may transmit or receive messages to the RU 605 via a set of one or more antennas 615. Additionally, the RU 605 may transmit or receive messages to the UE 120 via a set of antennas 620.

In some aspects, the RU 605 may be configured to receive a configuration 625 associated with SRS reporting from the DU 610, as described herein with respect to FIG. 5. In some aspects, the configuration 625 may be received via a first section type (ST) message (e.g., ST-X). For example, the configuration 625 may indicate one or more usage types for the SRS waveform, and may configure the RU 605 to issue usage-specific reports. Additionally, or alternatively, the configuration 625 may configure the RU 605 to report channel estimation information for SRS ports. For example, the configuration 625 may indicate that, for uplink scheduling, UEIDs may represent SRS ports.

The RU 605 may receive the SRS 630 from the UE 120, as described herein with respect to FIG. 5. For example, a channel associated with the SRS 630 may be represented by [symbol] _{64×4} (e.g., in the case where the UE 120 includes four antennas, as depicted in FIG. 5). In some examples, the SRS 630 may be associated with a usage type corresponding to uplink beamforming (e.g., uplink channel estimation). In an operation 635, the RU 605 may be configured to derive (e.g., estimate) an effective channel in accordance with the SRS 630 transmitted by the UE 120, as described herein with respect to FIG. 5. In some examples, the effective channel may be represented by H_{ST6,64×4}.

In some aspects, the RU 605 may be configured to transmit a report 640 to the DU 610, and the report 640 may provide information for uplink scheduling. In some examples, the report 640 may be an example of a second ST message (e.g., ST-Y). The report 640 may include channel estimates for SRS ports or logical ports, ensuring that the DU 610 has sufficient information to derive critical parameters like a TPMI for the UE 120, as described herein. In some aspects, the report 640 may include a mapping between channel estimates for logical ports and channel estimates for SRS ports. In some aspects, the report 640 may include an indication of the effective channel (e.g., H_{ST6_eff,4×64}), an antenna-domain DFT of the effective channel, an EVD associated with the effective channel for each antenna port associated with the UE 120

$$( e . g . , {EVDH}_{ST \_ eff , i \times 64} * {H}_{ST 6 \_ eff , i \times 64}^{H} ,$$

for all i, which for four antennas may be integer values between 1 and 4).

Additionally, or alternatively, the report 640 may also include channel estimates for SRS ports when the DU 610 requests such estimates. Accordingly, the DU 610 may directly utilize the SRS port channel information for uplink scheduling or TPMI determination. In some aspects, an identifier other than a UEID (e.g., used for logical ports) may be used for reporting SRS port channel information. Additionally, in some aspects, the RU 605 may include a delay or scope of SRS ports needed for logical channel reporting in the report 640. In some examples, the report 640 may be sent after all SRS ports have been sampled. In some aspects, a triggering of sending the report 640, or a triggering of a recalculation of channel estimates (e.g., for logical ports), may be performed implicitly or explicitly at the RU 605, as described herein with reference to FIG. 5.

In some aspects, different reports 640 may use the same or different identifiers to identify ports (e.g., logical ports or SRS ports). Additionally, or alternatively, the same port identifiers may be used for different purposes. For example, UEIDs may be used to identify either logical ports or SRS ports. In some aspects, when port identifiers are used for different purposes, ports identified by the port identifiers may be distinguished by context or associated purpose. For example, when the report 640 is associated with uplink scheduling, the port identifiers may correspond to SRS ports.

In some aspects, in an operation 645, the DU 610 may perform scheduling for the UE 120. For example, the DU 610 may schedule v layers for an uplink transmission for the UE 120. In some aspects, the scheduling may be performed in accordance with the report 640. For example, the scheduling may be performed in accordance with the effective channel, the antenna-domain DFT, the EVD associated with the effective channel, or other information included in the report 640. In some aspects, the scheduling may be performed for one or more ports, such as ports corresponding to a first identifier (e.g., UEID₁) to a v^{th} identifier (e.g., UEIDᵥ) in accordance with the v layers.

In some aspects, the DU 610 may send, to the RU 605, a message 650 that may include information for the RU 605 to perform beamforming, as described herein with reference to FIG. 5. For example, the message 650 may include information for beamforming associated with uplink beams for communications with the UE 120. In some examples, the message 650 may be a third ST message (e.g., ST-5) or a similar message type, and the message 650 may include one or more fields that may specify a beamforming type, a corresponding port type (e.g., SRS ports or logical ports), or a combination thereof.

In some aspects, to maintain a uniform message structure, the same field in a beamforming message may be interpreted to represent different port types depending on the context. For example, a beamforming type (S or L) associated with the report 640 may be used to determine the port type, where type S may correspond to SRS ports and type L may correspond to logical ports. In some examples, downlink beamforming may be of type L, and uplink beamforming may be of type S. Additionally, or alternatively, a direction field within the message 650 may indicate whether the beamforming is for downlink or uplink, and the direction field may thereby indicate the corresponding port type. Additionally, or alternatively, the RU 605 may determine a conversion between SRS ports and logical ports (e.g., based on a conversion matrix T), as described herein with reference to FIG. 5.

In some aspects, in an operation 655, the RU 605 may derive a combiner matrix W_{64×R}, where R may correspond to a quantity of spatial streams for the uplink transmission for reception of an uplink transmission in accordance with the channel estimation, the scheduling information, or both. In some aspects, the DU 610 and the RU 605 may exchange signaling associated with which SRIs (e.g., for non-codebook transmission) or which TPMI and SRIs combinations (e.g., for codebook transmissions) are scheduled (e.g., by the DU 610). For example, the SRIs or TPMI and SRIs combination may be indicated by the DU 610 in accordance with the report 640 including SRS channel estimation information. In some aspects, the SRIs or the TPMI and SRIs combinations may be used for determining the combiner matrix.

In some aspects, the UE 120 may be configured to transmit an uplink message 660 to the RU 605, and the RU 605 may be configured to receive the uplink message 660 in accordance with the combiner matrix. For example, the uplink message 660 may be represented by Equation 2 below:

$${W}_{R \times 64} {ℋ}_{64 \times 4} {P}_{4 \times 1} {Y}_{v} \qquad ( 2 )$$

where W_{R×64} represents the combiner matrix, [symbol] _{64×4} represents an uplink channel between the UE 120 and the RU 605, P_{4×1} represents a precoding matrix applied by the UE 120, and Yᵥ represents the data to be sent by the UE 120.

As indicated above, FIG. 6 is provided as an example. Other examples may differ from what is described with regard to FIG. 6.

FIG. 7 is a diagram illustrating an example process 700 performed, for example, at a first network node or an apparatus of a first network node. Example process 700 is an example where the apparatus or the first network node (e.g., first network node 110, an RU 240, an RU 505, or an RU 605) performs operations associated with SRS based beamforming.

As shown in FIG. 7, in some aspects, process 700 may include receiving, from a second network node, a configuration associated with an SRS for channel estimation associated with a UE, wherein the configuration indicates at least one report type associated with the SRS (block 710). For example, the first network node (e.g., using reception component 1402 or communication manager 1406, depicted in FIG. 14) may receive, from a second network node, a configuration associated with an SRS for channel estimation associated with a UE, wherein the configuration indicates at least one report type associated with the SRS, as described above.

As further shown in FIG. 7, in some aspects, process 700 may include receiving, from the UE, the SRS in accordance with the configuration (block 720). For example, the first network node (e.g., using reception component 1402 or communication manager 1406, depicted in FIG. 14) may receive, from the UE, the SRS in accordance with the configuration, as described above.

As further shown in FIG. 7, in some aspects, process 700 may include transmitting, to the second network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE (block 730). For example, the first network node (e.g., using transmission component 1404 or communication manager 1406, depicted in FIG. 14) may transmit, to the second network node, a report associated with the at least one report type, the report indicating a channel estimation based at least in part on the SRS, wherein the channel estimation includes at least one of a channel estimation for one or more SRS ports associated with the UE or a channel estimation for one or more logical ports associated with the UE, as described above.

Process 700 may include additional aspects, such as any single aspect or any combination of aspects described below or in connection with one or more other processes described elsewhere herein.

In a first aspect, the report includes an indication of the channel estimation for the one or more logical ports associated with the UE.

In a second aspect, alone or in combination with the first aspect, the mapping includes a transformation matrix for obtaining the channel estimation for the one or more SRS ports from the channel estimation for the one or more logical ports.

In a third aspect, alone or in combination with one or more of the first and second aspects, process 700 includes receiving, from the second network node, beamforming information associated with the UE in accordance with the mapping.

In a fourth aspect, alone or in combination with one or more of the first through third aspects, the at least one report type includes at least one of a downlink scheduling type, an uplink scheduling type, a downlink and uplink scheduling type, an antenna switch type, a codebook-based type, a non-codebook-based type, a beam management type, a positioning type, an SRS port type, a logical port type, or a usage type.

In a fifth aspect, alone or in combination with one or more of the first through fourth aspects, process 700 includes transmitting, to the second network node, an additional report in accordance with the configuration indicating at least two report types.

In a sixth aspect, alone or in combination with one or more of the first through fifth aspects, the report is associated with one or more identifiers that correspond to the one or more SRS ports or the one or more logical ports in accordance with the at least one report type.

In a seventh aspect, alone or in combination with one or more of the first through sixth aspects, transmitting the report includes transmitting, for each SRS port of the one or more SRS ports, a respective report in accordance with a completion of a sampling of the SRS port.

In an eighth aspect, alone or in combination with the seventh aspect, each respective report is transmitted in accordance with at least one of reception of a reporting flag from the second network node associated with the respective report, the sampling for the SRS port being completed in a slot, the sampling for all SRS ports of the one or more SRS ports being completed, or the sampling for a grouping of at least one SRS port, of the one or more SRS ports, configured for reporting being completed.

In a ninth aspect, alone or in combination with one or more of the first through eighth aspects, the transmitting of the report is delayed in accordance with a completion of a sampling of the one or more SRS ports.

In an tenth aspect, alone or in combination with the seventh aspect, the report is transmitted in accordance with at least one of reception of a reporting flag from the second network node associated with the report, the sampling for at least one SRS port of the one or more SRS ports being completed in a slot, the sampling for all SRS ports of the one or more SRS ports being completed, or the sampling for a grouping of at least one SRS port, of the one or more SRS ports, configured for reporting being completed.

In an eleventh aspect, alone or in combination with one or more of the first through tenth aspects, process 700 includes receiving, from the UE, one or more DMRSs for ULPI channel estimation, wherein the ULPI channel estimation is linked to the channel estimation via at least one identifier associated with the UE or at least one port associated with the UE.

In a twelfth aspect, alone or in combination with one or more of the first through eleventh aspects, process 700 includes receiving, from the second network node, combining information associated with combining the ULPI channel estimation and the channel estimation into a channel estimation for one or more slots.

In a thirteenth aspect, alone or in combination with one or more of the first through twelfth aspects, the combining information indicates at least one SRS port of the one or more SRS ports for linking with at least one DMRS.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a first network node or an apparatus of a first network node. Example process 800 is an example where the apparatus or the first network node (e.g., first network node 110, an RU 240, an RU 505, or an RU 605) performs operations associated with techniques for SRS based beamforming.

As shown in FIG. 8, in some aspects, process 800 may include receiving a first message from a UE or a network node, wherein a channel estimation for one or more ports associated with the UE are based at least in part on the first message (block 810). For example, the first network node (e.g., using communication manager 1406, depicted in FIG. 14) may receive a first message from a UE or a network node, wherein a channel estimation for one or more ports associated with the UE are based at least in part on the first message, as described above.

As further shown in FIG. 8, in some aspects, process 800 may include receiving a second message including beamforming information associated with a set of one or more UE ports associated with the UE, wherein the beamforming information includes a mapping from the set of one or more UE ports to a set of one or more logical ports (block 820). For example, the first network node (e.g., using reception component 1402 or communication manager 1406, depicted in FIG. 14) may receive a second message including beamforming information associated with a set of one or more UE ports associated with the UE, wherein the beamforming information includes a mapping from the set of one or more UE ports to a set of one or more logical ports, as described above.

Process 800 may include additional aspects, such as any single aspect or any combination of aspects described below or in connection with one or more other processes described elsewhere herein.

In a first aspect, the beamforming information includes at least one of a linear transformation from the set of one or more UE ports to the set of logical ports, one or more beamforming restrictions, one or more beamforming assumptions associated with the set of one or more UE ports, a beamforming type associated with the set of one or more UE ports, or a limitation associated with a quantity of logical ports that can be derived from the set of one or more UE ports.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a first network node or an apparatus of a first network node. Example process 900 is an example where the apparatus or the first network node (e.g., first network node 110, an RU 240, an RU 505, or an RU 605) performs operations associated with techniques for SRS based beamforming.

As shown in FIG. 9, in some aspects, process 900 may include transmitting, to a second network node, capability information associated with a grouping of one or more UE ports associated with a UE (block 910). For example, the first network node (e.g., using transmission component 1404 or communication manager 1406, depicted in FIG. 14) may transmit, to a second network node, capability information associated with a grouping of one or more UE ports associated with a UE, as described above.

As further shown in FIG. 9, in some aspects, process 900 may include receiving, from the second network node, an indication of the grouping of the one or more UE ports based at least in part on the capability information; and receiving, from the second network node, an indication that the grouping is associated with a downlink transmission or at least one UE port of the one or more UE ports for channel estimation to be derived based at least in part on sampling of an SRS from the UE (block 920). For example, the first network node (e.g., using reception component 1402 or communication manager 1406, depicted in FIG. 14) may receive, from the second network node, an indication of the grouping of the one or more UE ports based at least in part on the capability information; and receiving, from the second network node, an indication that the grouping is associated with a downlink transmission or at least one UE port of the one or more UE ports for channel estimation to be derived based at least in part on sampling of an SRS from the UE, as described above.

Process 900 may include additional aspects, such as any single aspect or any combination of aspects described below or in connection with one or more other processes described elsewhere herein.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a first network node or an apparatus of a first network node. Example process 1000 is an example where the apparatus or the first network node (e.g., first network node 110, an DU 230, a DU 510, or a DU 610) performs operations associated with techniques for SRS based beamforming.

As shown in FIG. 10, in some aspects, process 1000 may include transmitting, to a second network node, a configuration associated with an SRS for channel estimation associated with a UE, wherein the configuration indicates at least one report type associated with the SRS (block 1010). For example, the first network node (e.g., using transmission component 1504 or communication manager 1506, depicted in FIG. 15) may transmit, to a second network node, a configuration associated with an SRS for channel estimation associated with a UE, wherein the configuration indicates at least one report type associated with the SRS, as described above.

As further shown in FIG. 10, in some aspects, process 1000 may include receiving, from the second network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE (block 1020). For example, the first network node (e.g., using reception component 1502 or communication manager 1506, depicted in FIG. 15) may receive, from the second network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE, as described above.

Process 1000 may include additional aspects, such as any single aspect or any combination of aspects described below or in connection with one or more other processes described elsewhere herein.

In a first aspect, the report includes an indication of the channel estimation for the one or more logical ports associated with the UE.

In a second aspect, alone or in combination with the first aspect, the mapping includes a transformation matrix for obtaining the channel estimation for the one or more SRS ports from the channel estimation for the one or more logical ports.

In a third aspect, alone or in combination with one or more of the first and second aspects, process 1000 includes transmitting, to the second network node, beamforming information associated with the UE in accordance with the mapping.

In a fourth aspect, alone or in combination with one or more of the first through third aspects, the report type includes at least one of a downlink scheduling type, an uplink scheduling type, a downlink and uplink scheduling type, an antenna switch type, a codebook-based type, a non-codebook-based type, a beam management type, a positioning type, an SRS port type, a logical port type, or a usage type.

In a fifth aspect, alone or in combination with one or more of the first through fourth aspects, process 1000 includes receiving, from the second network node, an additional report in accordance with the configuration indicating at least two report types.

In a sixth aspect, alone or in combination with one or more of the first through fifth aspects, the report is associated with one or more identifiers that correspond to the one or more SRS ports or the one or more logical ports in accordance with the at least one report type.

In a seventh aspect, alone or in combination with one or more of the first through sixth aspects, receiving the report includes transmitting, for each SRS port of the one or more SRS ports, a respective report in accordance with a completion of a sampling of the SRS port.

In an eighth aspect, alone or in combination with the seventh aspect, each respective report is transmitted in accordance with at least one of reception of a reporting flag from the second network node associated with the respective report, the sampling for the SRS port being completed in a slot, the sampling for all SRS ports of the one or more SRS ports being completed, or the sampling for a grouping of at least one SRS port, of the one or more SRS ports, configured for reporting being completed.

In a ninth aspect, alone or in combination with one or more of the first through seventh aspects, the transmitting of the report is delayed in accordance with a completion of a sampling of the one or more SRS ports.

In an tenth aspect, alone or in combination with the seventh aspect, the report is transmitted in accordance with at least one of reception of a reporting flag from the second network node associated with the report, the sampling for at least one SRS port of the one or more SRS ports being completed in a slot, the sampling for all SRS ports of the one or more SRS ports being completed, or the sampling for a grouping of at least one SRS port, of the one or more SRS ports, configured for reporting being completed.

In an eleventh aspect, alone or in combination with one or more of the first through tenth aspects, process 1000 includes transmitting, to the second network node, combining information associated with combining an ULPI channel estimation and the channel estimation into a channel estimation for one or more slots.

In a twelfth aspect, alone or in combination with one or more of the first through eleventh aspects, the combining information indicates at least one SRS port of the one or more SRS ports for linking with at least one DMRS.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a first network node or an apparatus of a first network node. Example process 1100 is an example where the apparatus or the first network node (e.g., first network node 110, a DU 230, a DU 510, or a DU 610) performs operations associated with techniques for SRS based beamforming.

As shown in FIG. 11, in some aspects, process 1100 may include transmitting, to a second network node, a message including beamforming information associated with a set of one or more UE ports associated with a UE, wherein the beamforming information includes a mapping from the set of one or more UE ports to a set of one or more logical ports (block 1110). For example, the first network node (e.g., using reception component 1502 or communication manager 1506, depicted in FIG. 15) may receive, from a second network node, a second message including beamforming information associated with a set of one or more UE ports associated with a UE, wherein the beamforming information includes a mapping from the set of one or more UE ports to a set of one or more logical ports, as described above.

As shown in FIG. 11, in some aspects, process 1100 may include transmitting (e.g., via the beamforming information) at least one of a linear transformation from the set of one or more UE ports to the set of logical ports, one or more beamforming restrictions, one or more beamforming assumptions associated with the set of one or more UE ports, a beamforming type associated with the set of one or more UE ports, or a limitation associated with a quantity of logical ports that can be derived from the set of one or more UE ports (block 1115).

Process 1100 may include additional aspects, such as any single aspect or any combination of aspects described below or in connection with one or more other processes described elsewhere herein.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a first network node or an apparatus of a first network node. Example process 1200 is an example where the apparatus or the first network node (e.g., first network node 110, a DU 230, a DU 510, or a DU 610) performs operations associated with techniques for SRS based beamforming.

As shown in FIG. 12, in some aspects, process 1200 may include receiving, from a second network node, capability information associated with a grouping of one or more UE ports associated with a UE (block 1210). For example, the first network node (e.g., using reception component 1502 or communication manager 1506, depicted in FIG. 15) may receive, from a second network node, capability information associated with a grouping of one or more UE ports associated with a UE, as described above.

As further shown in FIG. 12, in some aspects, process 1200 may include transmitting, to the second network node, an indication of the grouping of the one or more UE ports based at least in part on the capability information (block 1220). For example, the first network node (e.g., using transmission component 1504 or communication manager 1506, depicted in FIG. 15) may transmit, to the second network node, an indication of the grouping of the one or more UE ports based at least in part on the capability information, as described above.

As further shown in FIG. 12, in some aspects, process 1200 may include transmitting, to the second network node, an indication that the grouping is associated with a downlink transmission or at least one UE port of the one or more UE ports for channel estimation to be derived based at least in part on sampling of an SRS from the UE (block 1230). For example, the first network node (e.g., using transmission component 1504 or communication manager 1506, depicted in FIG. 15) may transmit, to the second network node, an indication that the grouping is associated with a downlink transmission or at least one UE port of the one or more UE ports for channel estimation to be derived based at least in part on sampling of an SRS from the UE, as described above.

Process 1200 may include additional aspects, such as any single aspect or any combination of aspects described below or in connection with one or more other processes described elsewhere herein.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a UE or an apparatus of a UE. Example process 1300 is an example where the apparatus or the UE (e.g., UE 120) performs operations associated with techniques for SRS based beamforming.

As shown in FIG. 13, in some aspects, process 1300 may include receiving, from a network node, a configuration associated with an SRS for channel estimation associated with the UE, wherein the configuration indicates at least one report type associated with the SRS (block 1310). For example, the UE (e.g., using reception component 1602 or communication manager 1606, depicted in FIG. 16) may receive, from a second network node, a configuration associated with an SRS for channel estimation associated with a UE, wherein the configuration indicates at least one report type associated with the SRS, as described above.

As further shown in FIG. 13, in some aspects, process 1300 may include transmitting, to the network node, an SRS in accordance with a configuration associated with channel estimation, wherein the channel estimation includes a mapping between a channel estimation for one or more SRS ports associated with the UE and a channel estimation for one or more logical ports associated with the UE in accordance with the at least one report type (block 1320). For example, the UE (e.g., using transmission component 1604 or communication manager 1606, depicted in FIG. 16) may transmit, to a network node, an SRS in accordance with a configuration associated with channel estimation, wherein the channel estimation includes a mapping between a channel estimation for one or more SRS ports associated with the UE and a channel estimation for one or more logical ports associated with the UE in accordance with the at least one report type, as described above.

Process 1300 may include additional aspects, such as any single aspect or any combination of aspects described below or in connection with one or more other processes described elsewhere herein.

In a first aspect, the at least one report type includes at least one of a downlink scheduling type, an uplink scheduling type, a downlink and uplink scheduling type, an antenna switch type, a codebook-based type, a non-codebook-based type, a beam management type, a positioning type, an SRS port type, a logical port type, or a usage type.

In a second aspect, alone or in combination with the first aspect, process 1300 includes transmitting, to the network node, one or more DMRSs for ULPI channel estimation, wherein the ULPI channel estimation is linked to the channel estimation via at least one identifier associated with the UE or at least one port associated with the UE.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication. The apparatus 1400 may be a first network node (e.g., first network node 110, an RU 240, an RU 505, or an RU 605), or a first network node may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 155 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the first network node.

In some aspects, the apparatus 1400 may be configured to perform one or more operations described herein in connection with FIGS. 3-6. Additionally, or alternatively, the apparatus 1400 may be configured to perform one or more processes described herein, such as process 700 of FIG. 7, process 800 of FIG. 8, process 900 of FIG. 9, or a combination thereof. In some aspects, the apparatus 1400 or one or more components shown in FIG. 14 may include one or more components of the first network node described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the first network node described above in connection with FIG. 1, such as a radio, one or more RF chains, one or more transceivers, or one or more modems, each of which may in turn be coupled with one or more antennas of the first network node. In some aspects, the reception component 1402 or the transmission component 1404 may include or may be included in a network interface. The network interface may be configured to obtain or output signals for the apparatus 1400 via one or more communications links, such as a backhaul link, a midhaul link, or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the first network node described above in connection with FIG. 1, such as a radio, one or more RF chains, one or more transceivers, or one or more modems, each of which may in turn be coupled with one or more antennas of the first network node described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The reception component 1402 may receive, from a second network node, a configuration associated with an SRS for channel estimation associated with a UE, wherein the configuration indicates at least one report type associated with the SRS. The reception component 1402 may receive, from the UE, the SRS in accordance with the configuration. The transmission component 1404 may transmit, to the second network node, a report associated with the at least one report type, the report indicating a channel estimation based at least in part on the SRS, wherein the channel estimation includes at least one of a channel estimation for one or more SRS ports associated with the UE or a channel estimation for one or more logical ports associated with the UE.

The reception component 1402 may receive, from the second network node, beamforming information associated with the UE in accordance with the mapping.

The transmission component 1404 may transmit, to the second network node, an additional report in accordance with the configuration indicating at least two report types.

The reception component 1402 may receive, from the UE, one or more DMRSs for ULPI channel estimation, wherein the ULPI channel estimation is linked to the channel estimation via at least one identifier associated with the UE or at least one port associated with the UE.

The reception component 1402 may receive, from the second network node, combining information associated with combining the ULPI channel estimation and the channel estimation into a channel estimation for one or more slots.

The communication manager 1406 may determine a channel estimation for one or more ports associated with a UE based at least in part on receiving a first message. The reception component 1402 may receive, from a second network node, a second message including beamforming information associated with a set of one or more UE ports associated with the UE, wherein the beamforming information includes a mapping from the set of one or more UE ports to a set of one or more logical ports.

The transmission component 1404 may transmit, to a second network node, capability information associated with a grouping of one or more UE ports associated with a UE. The reception component 1402 may receive, from the second network node, an indication of the grouping of the one or more UE ports based at least in part on the capability information receiving, from the second network node, an indication that the grouping is associated with a downlink transmission or at least one UE port of the one or more UE ports for channel estimation to be derived based at least in part on sampling of an SRS from the UE.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a first network node (e.g., first network node 110, a DU 230, a DU 510, or a DU 610), or a first network node may include the apparatus 1500. In some aspects, the apparatus 1500 includes a reception component 1502, a transmission component 1504, or a communication manager 1506, which may be in communication with one another (for example, via one or more buses or one or more other components). In some aspects, the communication manager 1506 is the communication manager 155 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 145 described in connection with FIG. 1) of the first network node.

In some aspects, the apparatus 1500 may be configured to perform one or more operations described herein in connection with FIGS. 3-6. Additionally, or alternatively, the apparatus 1500 may be configured to perform one or more processes described herein, such as process 1000 of FIG. 10, process 1100 of FIG. 11, process 1200 of FIG. 12, or a combination thereof. In some aspects, the apparatus 1500 or one or more components shown in FIG. 15 may include one or more components of the first network node described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the first network node described above in connection with FIG. 1, such as a radio, one or more RF chains, one or more transceivers, or one or more modems, each of which may in turn be coupled with one or more antennas of the first network node. In some aspects, the reception component 1502 or the transmission component 1504 may include or may be included in a network interface. The network interface may be configured to obtain or output signals for the apparatus 1500 via one or more communications links, such as a backhaul link, a midhaul link, or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the first network node described above in connection with FIG. 1, such as a radio, one or more RF chains, one or more transceivers, or one or more modems, each of which may in turn be coupled with one or more antennas of the first network node described in connection with FIG. 1. In some aspects, the transmission component 1504 may be co-located with the reception component 1502.

The communication manager 1506 may support operations of the reception component 1502 or the transmission component 1504. For example, the communication manager 1506 may receive information associated with configuring reception of communications by the reception component 1502 or transmission of communications by the transmission component 1504. Additionally, or alternatively, the communication manager 1506 may generate or provide control information to the reception component 1502 or the transmission component 1504 to control reception or transmission of communications.

The transmission component 1504 may transmit, to a second network node, a configuration associated with an SRS for channel estimation associated with a UE, wherein the configuration indicates at least one report type associated with the SRS. The reception component 1502 may receive, from the second network node, a report associated with the at least one report type, the report indicating a channel estimation based at least in part on the SRS, wherein the channel estimation includes at least one of a channel estimation for one or more SRS ports associated with the UE or a channel estimation for one or more logical ports associated with the UE.

The transmission component 1504 may transmit, to the second network node, beamforming information associated with the UE in accordance with the mapping.

The reception component 1502 may receive, from the second network node, an additional report in accordance with the configuration indicating at least two report types.

The transmission component 1504 may transmit, to the second network node, combining information associated with combining an ULPI channel estimation and the channel estimation into a channel estimation for one or more slots.

The transmission component 1504 may transmit, to a second network node, a second message including beamforming information associated with a set of one or more UE ports associated with a UE, wherein the beamforming information includes a mapping from the set of one or more UE ports to a set of one or more logical ports.

The reception component 1502 may receive, from a second network node, capability information associated with a grouping of one or more UE ports associated with a UE. The transmission component 1504 may transmit, to the second network node, an indication of the grouping of the one or more UE ports based at least in part on the capability information. The transmission component 1504 may transmit, to the second network node, an indication that the grouping is associated with a downlink transmission or at least one UE port of the one or more UE ports for channel estimation to be derived based at least in part on sampling of an SRS from the UE.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a UE, or a UE may include the apparatus 1600. In some aspects, the apparatus 1600 includes a reception component 1602, a transmission component 1604, or a communication manager 1606, which may be in communication with one another (for example, via one or more buses or one or more other components). In some aspects, the communication manager 1606 is the communication manager 150 described in connection with FIG. 1. As shown, the apparatus 1600 may communicate with another apparatus 1608, such as a UE or a network node (such as a CU, a DU, an RU, or a base station), using the reception component 1602 and the transmission component 1604. The communication manager 1606 may be included in, or implemented via, a processing system (for example, the processing system 140 described in connection with FIG. 1) of the UE.

In some aspects, the apparatus 1600 may be configured to perform one or more operations described herein in connection with FIGS. 3-6. Additionally, or alternatively, the apparatus 1600 may be configured to perform one or more processes described herein, such as process 1300 of FIG. 13. In some aspects, the apparatus 1600 or one or more components shown in FIG. 16 may include one or more components of the UE described in connection with FIG. 1. Additionally, or alternatively, one or more components shown in FIG. 16 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications, and may provide the processed signals to the one or more other components of the apparatus 1600. In some aspects, the reception component 1602 may include one or more components of the UE described above in connection with FIG. 1, such as a radio, one or more RF chains, one or more transceivers, or one or more modems, each of which may in turn be coupled with one or more antennas of the UE.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications, and may transmit the processed signals to the apparatus 1608. In some aspects, the transmission component 1604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1604 may be co-located with the reception component 1602.

The communication manager 1606 may support operations of the reception component 1602 or the transmission component 1604. For example, the communication manager 1606 may receive information associated with configuring reception of communications by the reception component 1602 or transmission of communications by the transmission component 1604. Additionally, or alternatively, the communication manager 1606 may generate or provide control information to the reception component 1602 or the transmission component 1604 to control reception or transmission of communications.

The reception component 1602 may receive, from a network node, a configuration associated with an SRS for channel estimation associated with the UE, wherein the configuration indicates at least one report type associated with the SRS. The transmission component 1604 may transmit, to the network node, an SRS in accordance with a configuration associated with channel estimation, wherein the channel estimation includes at least one of a channel estimation for one or more SRS ports associated with the UE or a channel estimation for one or more logical ports associated with the UE in accordance with the at least one report type.

The transmission component 1604 may transmit, to the network node, one or more DMRSs for ULPI channel estimation, wherein the ULPI channel estimation is linked to the channel estimation via at least one identifier associated with the UE or at least one port associated with the UE.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a first network node, comprising: receiving, from a second network node, a configuration associated with an SRS for channel estimation associated with a UE, wherein the configuration indicates at least one report type associated with the SRS; receiving, from the UE, the SRS in accordance with the configuration; and transmitting, to the second network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE.

Aspect 2: The method of Aspect 1, wherein the report includes an indication of the channel estimation for the one or more logical ports associated with the UE.

Aspect 3: The method of Aspect 2, wherein the mapping includes a transformation matrix for obtaining the channel estimation for the one or more SRS ports from the channel estimation for the one or more logical ports.

Aspect 4: The method of any of Aspects 2-3, further comprising: receiving, from the second network node, beamforming information associated with the UE in accordance with the mapping.

Aspect 5: The method of any of Aspects 1-4, wherein the at least one report type includes at least one of a downlink scheduling type, an uplink scheduling type, a downlink and uplink scheduling type, an antenna switch type, a codebook-based type, a non-codebook-based type, a beam management type, a positioning type, an SRS port type, a logical port type, or a usage type.

Aspect 6: The method of any of Aspects 1-5, further comprising: transmitting, to the second network node, an additional report in accordance with the configuration indicating at least two report types.

Aspect 7: The method of any of Aspects 1-6, wherein the report is associated with one or more identifiers that correspond to the one or more SRS ports or the one or more logical ports in accordance with the at least one report type.

Aspect 8: The method of any of Aspects 1-7, wherein transmitting the report includes transmitting, for each SRS port of the one or more SRS ports, a respective report in accordance with a completion of a sampling of the SRS port.

Aspect 9: The method of Aspect 8, wherein each respective report is transmitted in accordance with at least one of reception of a reporting flag from the second network node associated with the respective report, the sampling for the SRS port being completed in a slot, the sampling for all SRS ports of the one or more SRS ports being completed, or the sampling for a grouping of at least one SRS port, of the one or more SRS ports, configured for reporting being completed.

Aspect 10: The method of any of Aspects 1-9, wherein the transmitting of the report is delayed in accordance with a completion of a sampling of the one or more SRS ports.

Aspect 11: The method of Aspect 10, wherein the report is transmitted in accordance with at least one of reception of a reporting flag from the second network node associated with the report, the sampling for at least one SRS port of the one or more SRS ports being completed in a slot, the sampling for all SRS ports of the one or more SRS ports being completed, or the sampling for a grouping of at least one SRS port, of the one or more SRS ports, configured for reporting being completed

Aspect 12: The method of any of Aspects 1-11, further comprising: receiving, from the UE, one or more DMRSs for ULPI channel estimation, wherein the ULPI channel estimation is linked to the channel estimation via at least one identifier associated with the UE or at least one port associated with the UE.

Aspect 13: The method of Aspect 12, further comprising: receiving, from the second network node, combining information associated with combining the ULPI channel estimation and the channel estimation into a channel estimation for one or more slots.

Aspect 14: The method of Aspect 13, wherein the combining information indicates at least one SRS port of the one or more SRS ports for linking with at least one DMRS.

Aspect 15: A method of wireless communication performed by a first network node, comprising: receiving a first message from a user equipment (UE) or a network node, wherein a channel estimation for one or more ports associated with the UE are based at least in part on the first message; receiving, from a second network node, a second message including beamforming information associated with a set of one or more UE ports associated with the UE, wherein the beamforming information includes a mapping from the set of one or more UE ports to a set of one or more logical ports.

Aspect 16: The method of Aspect 15, wherein the beamforming information includes a linear transformation from the set of one or more UE ports to the set of logical ports.

Aspect 17: The method of any of Aspects 15-16, wherein the beamforming information includes at least one of one or more beamforming restrictions or one or more beamforming assumptions associated with the set of one or more UE ports.

Aspect 18: The method of any of Aspects 15-17, wherein the beamforming information includes at least one of a beamforming type associated with the set of one or more UE ports or a limitation associated with a quantity of logical ports that can be derived from the set of one or more UE ports.

Aspect 19: A method of wireless communication performed by a first network node, comprising: transmitting, to a second network node, capability information associated with a grouping of one or more UE ports associated with a UE; receiving, from the second network node, an indication of the grouping of the one or more UE ports based at least in part on the capability information; and receiving, from the second network node, an indication that the grouping is associated with a downlink transmission or at least one UE port of the one or more UE ports for channel estimation to be derived based at least in part on sampling of an SRS from the UE.

Aspect 20: A method of wireless communication performed by a first network node, comprising: transmitting, to a second network node, a configuration associated with an SRS for channel estimation associated with a UE, wherein the configuration indicates at least one report type associated with the SRS; receiving, from the second network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE.

Aspect 21: The method of Aspect 20, wherein the report includes an indication of the channel estimation for the one or more logical ports associated with the UE.

Aspect 22: The method of Aspect 21, wherein the mapping includes a transformation matrix for obtaining the channel estimation for the one or more SRS ports from the channel estimation for the one or more logical ports.

Aspect 23: The method of any of Aspects 21-22, further comprising: transmitting, to the second network node, beamforming information associated with the UE in accordance with the mapping.

Aspect 24: The method of any of Aspects 20-23, wherein the report type includes at least one of a downlink scheduling type, an uplink scheduling type, a downlink and uplink scheduling type, an antenna switch type, a codebook-based type, a non-codebook-based type, a beam management type, a positioning type, an SRS port type, a logical port type, or a usage type.

Aspect 25: The method of any of Aspects 20-24, further comprising: receiving, from the second network node, an additional report in accordance with the configuration indicating at least two report types.

Aspect 26: The method of any of Aspects 20-25, wherein the report is associated with one or more identifiers that correspond to the one or more SRS ports or the one or more logical ports in accordance with the at least one report type.

Aspect 27: The method of any of Aspects 20-26, wherein receiving the report includes transmitting, for each SRS port of the one or more SRS ports, a respective report in accordance with a completion of a sampling of the SRS port.

Aspect 28: The method of any of Aspects 20-27, wherein the transmitting of the report is delayed in accordance with a completion of a sampling of the one or more SRS ports.

Aspect 29: The method of Aspect 28, further comprising: transmitting, to the second network node, combining information associated with combining an ULPI channel estimation and the channel estimation into a channel estimation for one or more slots.

Aspect 30: The method of Aspect 29, wherein the combining information indicates at least one SRS port of the one or more SRS ports for linking with at least one DMRS.

Aspect 31: A method of wireless communication performed by a first network node, comprising: transmitting, to a second network node, a second message including beamforming information associated with a set of one or more UE ports associated with a UE, wherein the beamforming information includes a mapping from the set of one or more UE ports to a set of one or more logical ports.

Aspect 32: The method of Aspect 31, wherein the beamforming information includes at least one of a linear transformation from the set of one or more UE ports to the set of logical ports, one or more beamforming restrictions, one or more beamforming assumptions associated with the set of one or more UE ports, a beamforming type associated with the set of one or more UE ports, or a limitation associated with a quantity of logical ports that can be derived from the set of one or more UE ports.

Aspect 33: A method of wireless communication performed by a first network node, comprising: receiving, from a second network node, capability information associated with a grouping of one or more UE ports associated with a UE; transmitting, to the second network node, an indication of the grouping of the one or more UE ports based at least in part on the capability information; and transmitting, to the second network node, an indication that the grouping is associated with a downlink transmission or at least one UE port of the one or more UE ports for channel estimation to be derived based at least in part on sampling of an SRS from the UE.

Aspect 34: A method of wireless communication performed by a UE, comprising: receiving, from a network node, a configuration associated with an SRS for channel estimation associated with the UE, wherein the configuration indicates at least one report type associated with the SRS; transmitting, to the network node, an SRS in accordance with a configuration associated with channel estimation, wherein the channel estimation includes a mapping between a channel estimation for one or more SRS ports associated with the UE and a channel estimation for one or more logical ports associated with the UE in accordance with the at least one report type.

Aspect 35: The method of Aspect 34, wherein the at least one report type includes at least one of a downlink scheduling type, an uplink scheduling type, a downlink and uplink scheduling type, an antenna switch type, a codebook-based type, a non-codebook-based type, a beam management type, a positioning type, an SRS port type, a logical port type, or a usage type.

Aspect 36: The method of Aspect 35, further comprising: transmitting, to the network node, one or more DMRSs for ULPI channel estimation, wherein the ULPI channel estimation is linked to the channel estimation via at least one identifier associated with the UE or at least one port associated with the UE.

Aspect 37: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-36.

Aspect 38: An apparatus for wireless communication at a device, the apparatus comprising one or more memories and one or more processors coupled to the one or more memories, the one or more processors configured to cause the device to perform the method of one or more of Aspects 1-36.

Aspect 39: An apparatus for wireless communication, the apparatus comprising at least one means for performing the method of one or more of Aspects 1-34.

Aspect 40: A non-transitory computer-readable medium storing code for wireless communication, the code comprising instructions executable by one or more processors to perform the method of one or more of Aspects 1-36.

Aspect 41: A non-transitory computer-readable medium storing a set of instructions for wireless communication, the set of instructions comprising one or more instructions that, when executed by one or more processors of a device, cause the device to perform the method of one or more of Aspects 1-36.

Aspect 42: A device for wireless communication, the device comprising a processing system that includes one or more processors and one or more memories coupled with the one or more processors, the processing system configured to cause the device to perform the method of one or more of Aspects 1-36.

Aspect 43: An apparatus for wireless communication at a device, the apparatus comprising one or more memories and one or more processors coupled to the one or more memories, the one or more processors individually or collectively configured to cause the device to perform the method of one or more of Aspects 1-36.

Aspect 44: A device comprising a processing system that includes one or more processors and one or more code-storing memories coupled with the one or more processors, the processing system configured to cause the device to perform the method of one or more of Aspects 1-36.

Aspect 45: A device comprising a processing system that includes processor circuitry and code-storing memory circuitry, the processing system configured to cause the device to perform the method of one or more of Aspects 1-36.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a respect to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A method of wireless communication performed by a first network node, comprising:
receiving, from a second network node, a configuration associated with a sounding reference signal (SRS) for channel estimation associated with a user equipment (UE), wherein the configuration indicates at least one report type associated with the SRS;
receiving, from the UE, the SRS in accordance with the configuration; and
transmitting, to the second network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE.

2. The method of claim 1, wherein the report includes an indication of the channel estimation for the one or more logical ports associated with the UE.

3. The method of claim 1, wherein the mapping includes a transformation matrix for obtaining the channel estimation for the one or more SRS ports from the channel estimation for the one or more logical ports.

4. The method of claim 1, further comprising:
receiving, from the second network node, beamforming information associated with the UE in accordance with the mapping.

5. The method of claim 1, wherein the at least one report type includes at least one of a downlink scheduling type, an uplink scheduling type, a downlink and uplink scheduling type, an antenna switch type, a codebook-based type, a non-codebook-based type, a beam management type, a positioning type, an SRS port type, a logical port type, or a usage type.

6. The method of claim 1, further comprising:
transmitting, to the second network node, an additional report in accordance with the configuration indicating at least two report types.

7. The method of claim 1, wherein the report is associated with one or more identifiers that correspond to the one or more SRS ports or the one or more logical ports in accordance with the at least one report type.

8. The method of claim 1, wherein transmitting the report includes transmitting, for each SRS port of the one or more SRS ports, a respective report in accordance with a completion of a sampling of the SRS port.

9. The method of claim 8, wherein each respective report is transmitted in accordance with at least one of reception of a reporting flag from the second network node associated with the respective report, the sampling for the SRS port being completed in a slot, the sampling for all SRS ports of the one or more SRS ports being completed, or the sampling for a grouping of at least one SRS port, of the one or more SRS ports, configured for reporting being completed.

10. The method of claim 1, wherein the transmitting of the report is delayed in accordance with a completion of a sampling of the one or more SRS ports.

11. The method of claim 10, wherein the report is transmitted in accordance with at least one of reception of a reporting flag from the second network node associated with the report, the sampling for at least one SRS port of the one or more SRS ports being completed in a slot, the sampling for all SRS ports of the one or more SRS ports being completed, or the sampling for a grouping of at least one SRS port, of the one or more SRS ports, configured for reporting being completed.

12. The method of claim 1, further comprising:
receiving, from the UE, one or more demodulation reference signals (DMRSs) for uplink performance improvement (ULPI) channel estimation, wherein the ULPI channel estimation is linked to the channel estimation via at least one identifier associated with the UE or at least one port associated with the UE.

13. The method of claim 10, further comprising:
receiving, from the second network node, combining information associated with combining the ULPI channel estimation and the channel estimation into a channel estimation for one or more slots.

14. The method of claim 11, wherein the combining information indicates at least one SRS port of the one or more SRS ports for linking with at least one demodulation reference signal (DMRS).

15. A method of wireless communication performed by a first network node, comprising:
receiving a first message from a user equipment (UE) or a network node, wherein a channel estimation for one or more ports associated with the UE are based at least in part on the first message; and
receiving, from a second network node, a second message including beamforming information associated with a set of one or more UE ports associated with the UE, wherein the beamforming information includes a mapping from the set of one or more UE ports to a set of one or more logical ports.

16. The method of claim 15, wherein the beamforming information includes a linear transformation from the set of one or more UE ports to the set of logical ports.

17. The method of claim 15, wherein the beamforming information includes at least one of one or more beamforming restrictions or one or more beamforming assumptions associated with the set of one or more UE ports.

18. The method of claim 15, wherein the beamforming information includes at least one of a beamforming type associated with the set of one or more UE ports or a limitation associated with a quantity of logical ports that can be derived from the set of one or more UE ports.

19. A method of wireless communication performed by a first network node, comprising:
transmitting, to a second network node, capability information associated with a grouping of one or more UE ports associated with at least one user equipment (UE);
receiving, from the second network node, an indication of the grouping of the one or more UE ports based at least in part on the capability information; and
receiving, from the second network node, an indication that the grouping is associated with a downlink transmission or at least one UE port of the one or more UE ports for channel estimation to be derived based at least in part on sampling of a sounding reference signal (SRS) from the at least one UE.

20. A method of wireless communication performed by a first network node, comprising:
transmitting, to a second network node, a configuration associated with a sounding reference signal (SRS) for channel estimation associated with a user equipment (UE), wherein the configuration indicates at least one report type associated with the SRS; and
receiving, from the second network node, a report associated with the at least one report type, the report indicating a channel estimation based at least in part on the SRS, wherein the channel estimation includes a mapping between a channel estimation for one or more SRS ports associated with the UE and a channel estimation for one or more logical ports associated with the UE.

21. The method of claim 20, wherein the report includes an indication of the channel estimation for the one or more logical ports associated with the UE.

22. The method of claim 20, wherein the mapping includes a transformation matrix for obtaining the channel estimation for the one or more SRS ports from the channel estimation for the one or more logical ports.

23. The method of claim 20, further comprising:
transmitting, to the second network node, beamforming information associated with the UE in accordance with the mapping.

24. The method of claim 20, wherein the report type includes at least one of a downlink scheduling type, an uplink scheduling type, a downlink and uplink scheduling type, an antenna switch type, a codebook-based type, a non-codebook-based type, a beam management type, a positioning type, an SRS port type, a logical port type, or a usage type.

25. The method of claim 20, further comprising:
receiving, from the second network node, an additional report in accordance with the configuration indicating at least two report types.

26. The method of claim 20, wherein the report is associated with one or more identifiers that correspond to the one or more SRS ports or the one or more logical ports in accordance with the at least one report type.

27. The method of claim 20, wherein receiving the report includes transmitting, for each SRS port of the one or more SRS ports, a respective report in accordance with a completion of a sampling of the SRS port.

28. The method of claim 20, wherein the transmitting of the report is delayed in accordance with a completion of a sampling of the one or more SRS ports.

29. The method of claim 28, further comprising:
transmitting, to the second network node, combining information associated with combining an uplink performance improvement (ULPI) channel estimation and the channel estimation into a channel estimation for one or more slots.

30. The method of claim 29, wherein the combining information indicates at least one SRS port of the one or more SRS ports for linking with at least one demodulation reference signal (DMRS).
